(19) United States
(12) Patent Application Publication
(10) Pub. No.: US 2023/0157296 A1
(43) Pub. Date: May 25, 2023

(54) METHODS OF REDUCING FUSARIUM CONTAMINATION

(71) Applicant: Taminco BV, Ghent (BE)

(72) Inventors: Harry Garita Alvarado, Curridabat (CR); Nico Achiel Vergote, Wannegem-Lede (BE)

(73) Assignee: Taminco BV, Ghent (BE)

(21) Appl. No.: 17/907,496

(22) PCT Filed: Mar. 24, 2021
(86) PCT No.: PCT/EP2021/057645

§ 371 Date: Sep. 27, 2022

Related U.S. Application Data
(60) Provisional application No. 62/993,944, filed on Mar. 24, 2020.

(51) Int. Cl. A01N 47/14; A01N 25/00; A01N 47/46

(52) U.S. Cl. CPC A01N 47/14; A01N 25/00; A01N 47/46

(57) ABSTRACT

The present disclosure describes methods of reducing Fusarium species propagules in soil of a field, including applying a composition including methyl isothiocyanate (MITC) or a compound that produces MITC as a degradate, or a functional equivalent or alternative thereof, wherein application of the composition reduces Fusarium propagule count in the soil by at least 15% compared the soil before treatment. An example Fusarium species is Fusarium oxysporum f. sp. Cubense Tropical Race 4 (Foc TR4) (a.k.a. Fusarium odoratissimum). Provided methods involve applying the composition to soil at least 40 cm below the soil surface, and/or applying the composition to soil and mixing/blending the soil to a depth of at least 60 cm below the soil surface to distribute the composition.

### FIELD OF THE DISCLOSURE

The current disclosure relates to control of soil-borne plant pathogens, such as the fungal pathogen Fusarium oxysporum f. sp. Cubense Tropical Race 4 (Foc TR4) (a.k.a., Fusarium odoratissimum). More particularly, it relates to compositions, systems, and methods that employ a composition including methyl isothiocyanate (MITC) or a compound that produces MITC as a degradate, or a functional equivalent thereof (such as an alternative Foc TR4 fumigant).

### BACKGROUND OF THE DISCLOSURE

Fusarium oxysporum f. sp. Cubense (Foc) is the causal agent of Panama disease. It poses a great risk to the global banana production. During the middle of the 20^{th} century, the banana Gros Michel was wiped out due to Foc Tropical Race 1. Since then, the banana industry changed to Cavendish banana.

In recent years, Foc Tropical race 4 (TR4) has begun to infect Cavendish banana. First reported in Southeast Asia, the fungus has spread out globally, and is detected as far as flung as Pakistan, Lebanon and Mozambique. Foc TR4 is a soil pathogen that affects banana plants by infecting the root system and then enters the plants through the vascular system, the hyphae of the fungus can move through the plant and reach stem and leaves. This pathogen is spread mainly due to human behavior, such as the movement of contaminated banana suckers, people, and equipment.

Once in the soil, F. oxysporum chlamydospores can survive for over 30 years. It is believed that a soil treatment will be necessary to control this fungi. However, no effective treatments or preventative measures are currently available.

### SUMMARY OF THE DISCLOSURE

This Summary is provided to introduce a selection of concepts, in a simplified form, that are further described below in the Detailed Description. This Summary is not intended to identify all key features or essential features of the claimed subject matter, nor is it intended to be used alone as an aid in determining the scope of the claimed subject matter.

Provided herein is a method of reducing Fusarium oxysporum f. sp. Cubense Tropical Race 4 (Foc TR4) (a.k.a. Fusarium odoratissimum) propagules in soil of a Musa field, including applying a including methyl isothiocyanate (MITC) or a compound that produces MITC as a degradate (or a functional equivalent or alternative thereof), wherein application of the composition reduces Foc TR4 propagule count in the soil by at least 15% compared to the Foc TR4 propagule count in the soil before treatment.

Also provided are method embodiments, including in combination with any of the mentioned embodiments, that further include planting at least one Musa tree in the treated soil after applying the composition. By way of example, the at least one Musa tree is planted in the treated soil: at least 3 days after the treatment; at least 5 days after the treatment; at least 7 days after the treatment; at least 10 days after the treatment; at least 12 days after the treatment; at least 14 days after the treatment; or more than 14 days after the treatment. In an example of this method embodiment, or in combination with any of the mentioned embodiments, the Musa tree is a Musa acuminata banana plant or a plantain plant. For instance, the Musa acuminata banana plant is optionally a Cavendish triploid (AAA) cultivar banana plant. Similarly, the plantain plant is optionally a Plantain triploid (AAB) Musa acuminata and Musa balbisiana hybrid plant.

### BRIEF DESCRIPTION OF THE DRAWINGS

FIG. 1 is a graph illustrating Foc TR4 colony growth after metam treatment, at the indicated dilutions.

FIG. 2 is a photograph showing growth of Foc TR4 colonies on PDA plates after exposure to metam sodium at seven dilutions. Top eight plates (two rows), 5 min incubation; bottom eight plates (two rows), 60 min incubation. The top left plate in each set of eight plates is a control (no metam sodium); the seven test plates in each set were treated with the following dilutions of metam sodium (from left to right and from top to lower row in each set): 1:10, 1:100, 1:1000, 1:10000, 1:100000, 1:1*10⁶, 1:10*10⁶. Representative plates are shown; two plates of each condition were examined.

FIG. 3 is a bar graph illustrating efficacy of Metam Sodium on the colony forming units at 1:100 dilutions after 5 and 60 minutes (±SD).

FIG. 4 is a bar graph illustrating the average number of leaves per banana plant at the specified levels of metam sodium soil treatment (L/ha).

FIG. 5 is a bar graph illustrating the average height (cm) of banana plant at the specified levels of metam sodium soil treatment (L/ha).

FIG. 6 is a bar graph illustrating the average girth size (cm) of banana plant at the specified levels of metam sodium soil treatment (L/ha).

FIG. 7 is a bar graph illustrating the percentage of plants per treatment which reached shooting stage six months after treatment, at the specified levels of metam sodium soil treatment (L/ha).

FIG. 8 is a bar graph illustrating the percentage of plants per treatment which reached bagging stage by six months after treatment, at the specified levels of metam sodium soil treatment (L/ha).

FIG. 9 is a bar graph illustrating the percentage of plants which reached either shooting or bagging stage by six months after treatment, at the specified levels of metam sodium soil treatment (L/ha).

### DETAILED DESCRIPTION

Aspects of the disclosure are now described with additional detail and options to support the teachings of the disclosure, as follows: (I) Select Abbreviations; (II) Select Definitions; (III) Reducing Fusarium Infection of Musa Genus Plants; (IV) Target Organisms; (V) Active Ingredient; (VI) Additional Optional Components in Formulations; (VII) Methods of Making Formulations; (VIII) Uses of Formulations; (IX) Methods for Cyclic Treatment and Planting to Extend Productivity; (X) Additional Disclosure; (XI) Examples; and (XII) Closing Paragraphs.

### (I) Select Abbreviations

Foc Fusarium oxysporum f. sp. Cubense

Foc TR4 Fusarium oxysporum f. sp. Cubense Tropical Race 4 (a.k.a., Fusarium odoratissimum)

L/ha liters per hectare

MITC methyl isothiocyanate

RTU ready to use

SL soluble liquid

TR Tropical Race

### (II) Select Definitions

Use of the word(s), “exemplary” or “embodiment” or “desirably” in this document does not limit the definition or language with which the word(s) is used, and is intended to further illustrate in a non-limiting fashion meaning through use of an example or particular embodiments within the scope of the definition.

Active agent as used herein refers to a chemical or compound that has a particular biological activity. Active agents may include chemicals or compounds that have acaricidal activity, bactericidal activity, fungicidal activity, herbicidal activity, insecticidal activity, larvicidal activity, nematocidal activity, miticidal activity, molluscicidal activity, piscicidal activity, rodenticidal activity, slimicidal activity, or are a fertilizer, a hormone and/or other growth regulator. Additional active ingredients are listed herein. In addition, active agents may include chemicals or compounds that support or enhance plant growth. Active agents may also be referred to as active ingredients.

Adjuvants as used herein refers to an ingredient that aids or modifies the biological activity and/or physical properties of a formulation.

The use of adjuvants with agricultural chemicals generally falls into four categories: (1) activator adjuvants which generally enhance performance of a formulation, (2) spray modifier adjuvants which generally affect the application performance of spray solutions (e.g. drift retardants, stickers, evaporation aids), (3) utility modifiers which generally minimize handling and improve application (e.g., anti-foam agents), and (4) utility products that minimize application problems (e.g. foam markers and tank cleaners).

Agriculturally acceptable adjuvant as used herein refers to a substance that enhances the performance of an active agent in a composition that is used to influence (that is, inhibit or enhance, depending on circumstances) the growth or cultivation of plants and/or plant parts.

Agrochemical as used herein refers to any chemical substance used to help manage an agricultural ecosystem, such as, for example, a hormone or other growth regulator, a pesticide (such as an herbicide, insecticide, fungicide, nematicide, miticide, larvicide, molluscicide, and so forth), a fertilizer, a soil conditioner, a liming agent, an acidifying agent, or any other growth agent.

Ambient temperature as used herein refers to the temperature at a location or in a room, or the temperature which surrounds an object under discussion. This term is equivalent to “room temperature” (rt). By way of example, room temperature may be between 65° F. and 78° F. (about 18.3° C. to 25.5° C.); or between 68° F. and 72° F. (about 20° C. to 22.2° C.).

Anti-freeze as used herein refers to a material that lowers the freezing point of a formulation.

Aqueous dispersion as used herein refers to a water-based formulation in which a compound has been dispersed. In one embodiment, or in combination with any of the mentioned embodiments, an aqueous dispersion of a sulfopolyester is a formulation in which a sulfopolyester compound has been dispersed in water. An aqueous dispersion formulation can have a continuous phase of water in contrast to a continuous phase of organic solvent.

Colorant as used herein is any substance used to intentionally alter the color of a formulation.

Concentrate formulation (a.k.a., formulate concentrate) as used herein refers to a formulation that contains at least one active agrochemical compound at a level at least two-times the level used in an as-applied formulation, or at a level higher than the level at which the active ingredient is in a ready to use (RTU) formulation. Thus, a concentrate formulation is expected or intended to be diluted (for instance, with water or another acceptable carrier or diluent) before use or application. In one embodiment, or in combination with any of the mentioned embodiments, a concentrate formulation includes at least one active ingredient at a level that is at least twice as concentrated as that ingredient would be used in an as-applied or RTU formulation. A concentrate formulation as the term is used herein is a liquid at 25° C. and 1 atm.

Control formulation as used herein is a formulation that contains the same ingredients as a reference formulation, but without methyl isothiocyanate (MITC) or a compound that produces MITC as a degradate (or a functional equivalent thereof, such as an alternative Foc TR4 fumigant). Optionally, the control formulation may include alternative fungicide(s) in place of the MITC or a compound that produces MITC as a degradate, such as art-recognized fungicide(s) that are believed to perform function(s) similar to the function(s) for which the MITC or a compound that produces MITC as a degradate is included in one embodiment or in combination with any of the mentioned embodiments of the reference formulation.

Degradate as used herein refers to a chemical product resulting from degradation of another compound, such as a pesticide. Synonyms of the word degradate include breakdown product. A degradate can be viewed as a compound generated by the degradation or breakdown of a starting chemical; that starting chemical can be viewed as “generating” the degradate. For instance, MITC is a degradate of metam sodium.

Diluent as used herein refers to a gas, liquid, or solid used to reduce the concentration of an active ingredient in the formulation or application of an agrochemical composition.

Dispersion as used herein refers to a system in which distributed particles of one material are uniformly dispersed in a continuous phase of another material. It is contemplated that the distributed particles may be solid or liquid particles, which may be dispersed in a continuous liquid phase.

Dispersibility as used herein refers to the ability of one material to uniformly disperse in a continuous phase of another material. Re-dispersibility as used herein refers to the ability of particles to disperse in a mixture after settling or sedimenting of the particles.

Effective amount as used herein refers to an amount sufficient to cause a beneficial and/or desired result. For example, an active ingredient can be present in a formulation at an amount effective to provide the desired effect linked to that active ingredient, such as a fungicidal effect, a fertilizer effect, or any other agrochemical effect. The amount of any active or other ingredient that is effective for its desired use is usually influenced by what ingredient is being used, the context in which it is used (for instance, other components in a formulation), the method or manner in which the composition containing the ingredient is being used, and so forth. An effective amount for any particular ingredient and in various contexts can be determined using art-recognized methods. One example of an effective amount is an amount sufficient to reduce the level (number) of fungal or nematode propagules, for instance in a volume of soil.

An equivalent as the term is used herein refers to a measure that equalizes the quantity of a preparation, composition, or compound required to produce a specified level or amount of compound, product, degradate, or sub-compound. The use of an “equivalent” enables simpler comparison between multiple preparations, compositions, or compounds that may have different potencies from each other. For instance, one composition or preparation may provide a higher (or lower) effective amount of a desired end product than a composition or preparation to which it is being compared, but the appropriate amount of each to use in a method can be compared and converted by reference to an equivalent. By way of example, a methyldithiocarbamate equivalent is the amount of some starting compound (such as metam sodium) necessary to produce a desired or set amount of methyldithiocarbamate.

Flowable concentrate as used herein refers to a suspension of one or more solid active ingredients (at a level at least two-times the level used in an as-applied or RTU formulation) in water.

Functional equivalent as used herein refers to a practice, method, technique, procedure, material, or component that performs the same function and provides the same or improved utility as is being specified. Thus, a functional equivalent of MITC or of a compound that generates MITC includes any other compound that possesses or exhibits the same utility as MITC, for instance in treating, reducing, or controlling Fusarium oxysporum f. sp. Cubense Tropical Race 4 (Foc TR4) (a.k.a. Fusarium odoratissimum) in a Musa field.

Granule as used herein refers to a small, compact, distinguishable pieces or particle of a substance. In general a granule is solid formulation comprising particles of defined size, for instance >80 µm diameter, for application without further dilution, for instance to soil. A granule may contain one or more active ingredient(s) along with one or more inert components, such as bulking ingredients.

Inert Ingredient or Component as used herein refers to any substance other than an active ingredient (such as an agrochemical active ingredient) that is intentionally included in a formulation. Non-limiting examples of inert ingredients include emulsifiers, solvents, carriers, sticker agents, surfactants, drift control agents, drought control agents, fragrances, dyes and adjuvants with spreader activity, with rain fastness activity, and so forth.

Inert Package as used herein refers to a pre-mixed composition the provides one or more inert component(s) for use in an agrochemical formulation. An inert package is added to a formulation (such as a concentrate formulation) that contains at least one active agrochemical ingredient, for instance concurrently with the formulation being diluted for application to a plant, plant part, or growth medium. Different inert packages can be formulated to be paired with different active ingredient formulations, as will be recognized by those of ordinary skill in the art.

An inert package may provide at least one adjuvant function, such as for instance an emulsifier, a sticker, a drift control agent, a spreader, a rain fastness agent, and so forth. Additional examples of inert packages provide two or more such adjuvant functions. A “complete” inert package provides all of the adjuvant function(s) that are needed for use with a particular agrochemical formulation.

By way of example, an inert package can include MITC or at least one compound that produces MITC as a degradate (or an alternative Foc TR4 fumigant), as described herein. In one embodiment or in combination with any of the mentioned embodiments, the compound that produces MITC as a degradate is or contains metam sodium.

Loadings as used herein refers to the amount of a material in a given volume. For agricultural formulations, loading(s) often refers to the amount of active ingredient in the formulation, represented for instance as a g/liter percentage.

Pest as used herein is any organism (including microorganisms) in a circumstance that makes the presence of the pest undesirable. It is recognized that a pest in exemplary instances is a plant (e.g., a weed), a microorganism (such as a fungus, bacteria, nematode, and so forth), an insect (including any phase or life cycle of an insect, such as eggs, larvae, or adult insects), a mollusk (such as a slug or snail), or a larger animal (such as a rodent, bird, fish, and so forth).

Pesticide as used herein include any substance or mixture of substances intended for preventing, destroying, repelling, or mitigating any unwanted pests, wherein a pest is any organism that may have an impact on a crop. There are many subcategories of pesticides, which include: insecticides, herbicides, rodenticides, bactericides, fungicides, larvicides, miticides, molluscicides, nematicides, and so forth.

Plant as used herein refers to a whole plant including any root structures, vascular tissues, vegetative tissues, and reproductive tissues. A “plant part” includes any portion of a plant. For example, upon harvesting a tree, the tree separated from its roots becomes a plant part. Plant parts also include flower, fruits, leaves, bark, vegetables, stems, roots, branches, seeds, and combinations thereof that are less than the whole plant.

Powder as used herein means particles in the range of 0.5-5000 µM. The science and technology of small particles is known as “micrometrics” (for a general review, see ‘Physical Pharmacy and Pharmaceutical Sciences’ Fifth Edition by Patrick J. Sinko, Lippincott Williams & Wilkins, 2006, ISBN: 0-7817-5027-X). The unit commonly used to describe particle size is the micrometer (µm). In general, optical microscopy may be used to measure particle-sizes of 0.2 to 100 µm; however, other techniques may also be used to determine approximate size ranges, such as sedimentation, coulter counter, air permeability, sieving, etc.

Techniques such as sieving, according to methods of the U.S. Pharmacopeia, may be used to determine ‘powder fineness’, or other properties of the corresponding powders and/or powder blends; for example, particle size and size distribution (i.e. average particle size, particle-size distribution (frequency distribution curve), number and weight distributions, particle number), particle volume, particle shape and surface area, pore size, porosity, particle density, bulkiness, flow properties, etc. Because many powders have a tendency to contain a non-symmetric particle size distribution, it is common to plot the log-normal distribution; commonly, this method results in a linear relationship. Subsequently, the “geometric mean diameter” (dg; the particle size equivalent to 50% on the probability scale) may be obtained from plotting the logarithm of the particle size against the cumulative percent frequency on a probability scale. Therefore, as used throughout this application, powders shall be classified into different particle size ranges, such as: ‘extremely fine powders’ (i.e. dusty powders; 0.5-50 µm), ‘fine powders’ (50-100 µm), ‘coarse powders’ (100-1000 µm), and ‘granular powders’ (1000-5000 µm).

Preservative as used herein is any chemical that inhibits or suppresses decomposition of a product or formulation, such as an agrochemical formulation.

Propagule as used herein refers to any material that functions in propagating an organism, for instance a biological unit form which a new individual organism can develop. This includes both sexually an asexually produced propagules, such as spores, endospores, seeds, cysts, eggs, hyphae, hyphal fragments, tissue fragments, and the like. Propagules can be viewed as include both viable and non-viable propagules, where a viable propagule is in fact capable of producing or growing into a new individual organism (given appropriate circumstances and time).

Sprayability as the term is used herein refers to the ability of a liquid or gel to be driven or dispersed in air as, for example, particles, drops or droplets

Surfactant as used herein refers to a compound that lowers the surface tension (or interfacial tension) between two liquids, between a gas and a liquid, or between a liquid and a solid. Surfactants may act as detergents, wetting agents, emulsifiers, foaming agents, and dispersants. Surfactants may amphoteric, nonionic, and/or anionic. In an agrochemical formulation, surfactants may influence one or more of: emulsification, dispersion of active ingredient(s), spreading, and/or wetting.

Suspension as used herein refers to a heterogeneous mixture that contains solid particles dispersed in a liquid where the solid particles do not completely dissolve in the liquid. The particles may be visible to the naked eye and may eventually settle, although the mixture is only classified as a suspension when and while the particles have not settled out.

Suspension concentrate (SC) as used herein refers to a stable fluid suspension of small particles of solid active ingredient(s) (where at least one active agrochemical compound/ingredient is at a level at least two-times the level used in an as-applied or RTU formulation) in a liquid phase, such as water, that is intended for dilution with water before use. Suspension concentrate formulations (SCs) may also be referred to as flowable concentrate formulations. The liquid phase of a SC can be either water-immiscible solvent (e.g., oil) based, or water based, depending on the specific active ingredient(s) and the application of interest. The concentrate is often diluted into a larger volume of water at the point of use, such as a farm (for an agrochemical suspension concentrate).

As a suspension concentrate is stored over time, it is not uncommon for at least some of the solid particles to settle to the bottom of the container. This settling can lead to very hard cakes at the bottom of the container that require significant agitation to break apart and re-suspend. In many cases, this solid cake formation leads to particle sizes in the tank mix that can clog or plug spray nozzles and lines, and render the formulation unusable. Some SC formulations require significant agitation to ensure that the solid particles are dispersed sufficiently to avoid equipment plugging and to enable complete addition to the tank.

Ready to use as used herein refers to a formulation that requires no further dilution before application.

Tank mix as used herein refers to two or more chemical pesticides, inert ingredients, components, or formulations, mixed in the spray tank at the time of spray application or immediately before.

Thickener as used herein refers to a material a primary function of which is to increase the viscosity of a fluid.

Treat or treatment as used herein refers to methods used to effect a desired effect, such as the reduction of the contamination of a soil or water sample with a pest (e.g., a fungus or a nematode). Thus, treating a field may refer to applying a composition containing a sufficient amount/level of at least one active ingredient to effect the desired effect, such as reduction in the measurable number of propagules for a selected pest in soil from the field.

Volatilization as used herein refers to the process by which a dissolved sample is vaporized or a solid residue is sublimed.

Water Hardness as used herein is a measure of the amount of minerals that are present in water. Hardness is typically expressed in milligrams of dissolved calcium and magnesium carbonate per liter of water; however, other bivalent and trivalent metallic elements may contribute to water hardness.

### (III) Reducing Fusarium Infection Of Musa Genus Plants

Banana is the most exported fruit in the world and the 5th most produced in the least developed countries, being a valuable market commodity but also an important staple food or source of income in developing countries for approximately 400 M people. This crop has serious soil disease as it is being affected by Fusarium oxysporum f. sp. Cubense Tropical Race 4 (Foc TR4); this jeopardizes continuous production and increased productivity of banana and other Musa species. Currently, there is no chemical, organic or non-organic, being used effectively against Foc TR4. Described herein is an application method employing metam sodium to reduce Foc TR4 infestation, by making injection at one or more selected depths below the soil surface, which protects the root zone with sufficient metam sodium to mitigate Foc TR4 infection in Musa plants subsequent introduced into the treated field, allowing continued stable crop production. Optionally, a stewardship program can be employed which assists growers and distributors as needed to have a safe application process.

As described in Example 2, metam sodium injection at a depth of 30 cm and 60 cm can be used to control Foc TR4, and will give banana and plantain growers a broader production timeframe and in this way continue production to obtain return on investment (ROI), maintain jobs of workers, and support in the economy of countries were Musa crops are produced.

This methods and compositions described herein can be used in all Musa (e.g., banana and plantain) producing countries, including particularly were the Cavendish variety is produced, where the Foc TR4 Panama wilt disease is present. These methods and compositions are also applicable in countries, regions, or fields were the disease has not yet arrived, for instance as preventive applications. Representative countries were the application of metam sodium is believed likely to be of use in controlling or reducing Foc TR4 infection of Musa plants include: Philippines, Indonesia, Malaysia, China, Vietnam, Australia, New Zealand, Lebanon, Oman, Israel, Jordan, India, Mozambique, Kenia, Mexico, Honduras, Guatemala, Costa Rica, Belize, Colombia, Ecuador, Peru, and Brazil.

In one example, metam sodium (at 510 g/L soluble liquid (SL)) is applied with following characteristics:
at a dose between 750-3,000 L/Ha (liters per hectare);
when soils are “well prepared” before the injection of the metam sodium product; “well prepared” in this context means the soil is rototilled or otherwise treated to least break the soil structure from 0 cm to 80 cm below the soil surface, to allow the injection to have a smooth and even application by the machine; the soil is leveled and substantially uniform, so applicator machine and tractor can advance at a similar pace in all soil in which the metam sodium injection will take place.

Temperature of the soil should be a minimum of 10° C. so the applied product can transform from metam sodium (liquid) to MITC (gas), which is the active ingredient that kills the fungi Foc TR4 (including its chlamydospores).

The MITC-liberating (e.g., metam-containing) product is optimally distributed within or throughout the rootzone of the plant (at least 60 cm deep in the soil), so it will become gas and move upwards and kill Foc TR4 hyphae and chlamydospores through substantially all of the rootzone.

At the time of treatment, it is beneficial if the soil is humid, at least between 50-60% field capacity, to assist the product in reducing viability of the Foc TR4 fungi.

### (IV) Target Organism(s)

Provided herein are methods, compositions, and systems that enable management of production from Musa genus plants in the presence of the infectious agent Fusarium oxysporum f. sp. Cubense Tropical Race 4 (Foc TR4). This fungus is also known as Fusarium odoratissimum. See “Technical Manual, Prevention and diagnostic of Fusarium Wilt (Panama disease) of banana caused by Fusarium oxysporum f. s. Cubense Tropical Race 4 (TR4)″, Food and Agriculture Organization of the United Nations, May 2014 (74 pages); available online at fao.org/3/a-br126e.pdf.

The life cycle of Fusarium oxysporum f. sp. Cubense in banana or other Musa genus plants generally proceeds as follows (Dita et al., Front Plant Sci. 19(9):1468, 2019): 1) Spores (micro and macro conidia and chlamydospores) rest in the soil or on alternative hosts, such as weeds. 2) Chlamydospores germinate stimulated by root exudates and the germ-tubes penetrate banana roots. 3) Foc grows through the cortex to the epidermis and mycelium invades the vascular system. 4) Conidia and chlamydospores are constantly produced in the vascular tissues. Conidia are rapidly distributed through the plant via its transpiration system. Mycelium and resultant gum blocks the vascular tissues and first symptoms of yellowing are observed in the older leaves. (5) Foc colonizes and destroys more vascular tissues, provoking intense wilting. (6) Infected plant dies and the follower plant (daughter), which was contaminated by the mother plant through vascular connection, shows initial symptoms. 7) The mother plant eventually falls down and disease cycle starts again.

It is this life cycle that makes addressing Foc TR4 difficult. Foc is able to survive in the absence of its primary host through the chlamydospores, which are thick-walled spores that are designed for survival. They are resistant to desiccation, resilient in unfavorable environmental conditions, and this type of spores has been shown to survive in the soil for more than 20 years (Stover, Commonwealth Mycological Inst., Kew, UK, 1962; Buddenhagen, Acta Hortic. 828:193-204, 2009). Chlamydospores of Foc are constantly produced once the host is invaded, even before external symptoms are visible (Li et al., EurJ Plant Pathol. 131 :327-340, 2011), and not just after the death of the banana plant. The capacity of Foc to colonize and grow saprophytically in debris increases chlamydospore production and contributes to increased pathogen persistence in the soil (Dita et al., Front Plant Sci. 19(9):1468, 2019).

### (V) Active Ingredient

Provided herein is the discovery that methyl isothiocyanate (MITC) and compounds that produce MITC as a degradate are particularly useful in combatting Fusarium species, such as Foc TR4, through soil treatment prior to planting Musa genus plants in fields that are suspected to be or may become contaminated with the fungus. Although exemplified herein with the compound metam sodium (a recognized soil fumigant, used for instance to control nematode infestations; Runia & Molendijk, Commun Agric. App. Biol Sci, 72(3):687-691, 2007), it is believed that other compounds that produce MITC as a degradate, as well as MITC itself (marketed as Trapex™), will also be useful in the methods and systems described herein. These compounds include for instance: Dazomet (C₅H₁₀N₂S₂; marketed as Basamid®, Dacron), a dry granular compound that produces MITC as a degradate; Metam (C₂H₅NS₂; a.k.a., methyldithiocarbamate, methylcarbamodithioic acid); Metam Sodium (C₂H₄NNaS₂; marketed as Metam 426, Polefume, Turfcure, Vapam®, Vapam® HL, Busan 1236, Nemasol®, Maposol®, Metam CLR™, Sectagon-42®, Sistan™ , Trimatron™, Meter, Soldier, etc.), Metam Potassium (C₂H₄NKS₂; marketed as Curtin, Metam KLR, K-Pam HL, Raisan K-50, Sectagon K-54, etc.), and Metam Ammonium (C₂H₈N₂S₂; N-methyl-dithiocarbamate, marketed as carbam, NCS®).

The following are structures of example active ingredient compounds:

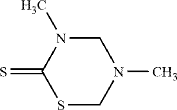

Dazomet

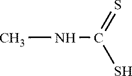

Metam

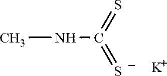

Metam potassium

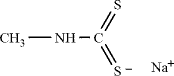

Metam sodium

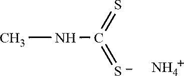

Metam ammonium

MITC is referred to herein as an active ingredient that functions as the fungicide to reduce Foc TR4. MITC consists of an isothiocyanate and a methyl group; it is believed that the isothiocyanate provides one or more antifungal activity(s) of the molecule. The following illustrates the structures of metam sodium and the MITC that it liberates.

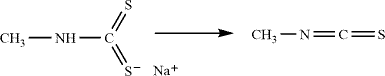

Metam Sodium MITC

Metam sodium is a representative dithiocarbamate that converts to (which may also be referred to as liberates, degrades to, produces as a degradate, and/or releases) MITC; other dithiocarbamates can also produce MITC as a degradate. The category “dithiocarbamate pesticides” includes Dazomet, metam potassium, metam ammonium, Ferbam, Ziram, Nabam, Thiram, Zineb, Maneb, Mancozeb, Metiram, and Propineb. The following illustrates the generic structure of dithiocarbamates:

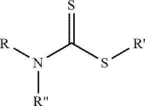

R and R″ can be both independently a linear or branched alkyl group or an alkenyl group such as methyl, ethyl, propyl, allyl, isopropyl, butyl, isobutyl, sec-butyl, and tert-butyl. R or R″ can also be H. R and R″ cannot both be H.

For instance, allyl-ITC is a naturally occurring compound, found for instance in Brassica species, that is responsible for the mustard taste. It is part of the plant’s own defense mechanisms. Allyl dithiocarbamate has reported antifungal activity.

As X-ITC has only one substituent on the nitrogen atom, one of the R or R″ – N bonds need to break during X-ITC formation. This is most easily achieved with H, as protons are very mobile. In dazomet, this is achieved because the N—CH₂—N—CH₂—S part is prone to hydrolysis. A dithiocarbamate with R and R″ both alkyl, may convert to MITC much more slowly; for instance thiram (R, R″ = Me).

The alkyl group of R or R″ may contain further heteroatoms such as N, O or S. Therefore, R and R″ may contain further functional groups such as alcohols, amines, carboxylic acids/esters, and further dithiocarbamate groups. Exemplars include, for instance, mancozeb, propineb, and metiram.

The alkyl group of R and R″ may form a cyclic structure.

R′ may be an inorganic or organic cationic species, such as Na, K, Zn, Mn, Fe, ammonium, alkylammonium, and so forth. In case R′ is a polyvalent cation, such as Zn²⁺, Mn²⁺, Fe³⁺, and so forth, it may bind together two or more isothiocarbamate groups. Exemplars include, for instance, mancozeb and propineb.

R′ may also be an alkyl group or an alkenyl group such as methyl, ethyl, propyl, allyl, isopropyl, butyl, isobutyl, sec-butyl, and tert-butyl.

R′ may form a cyclic structure with R or R″; an exemplar of this form is dazomet.

MITC is one of many forms of isothiocyanate (ITC). Being the lightest member of the ITC family, it is the most volatile and therefore likely to be the most mobile in soil. The following illustrates the structure of ITC (where X can be as described herein):

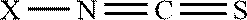

The isothiocyanate portion of MITC is believed to provide at least an element of its antifungal action(s). Further, it is understood that the methyl group is one exemplary alkyl group, and other alkyl groups attached to an isothiocyanate group may also provide the similar fungicidal action to that demonstrated herein for MITC. As such, other functional groups such as ethyl, propyl, allyl, isopropyl, butyl, isobutyl, sec-butyl, and tert-butyl may be substituted for the methyl group in MITC (referred to more generally as X-ITC) in one embodiment or in combination with any of the mentioned embodiments provided herein. These groups may be present in the final composition or degradate, or in the initial chemical structure. For example, ethylene-dis-dithiocarbamates and propylene-bis-dithiocarbamates that form isothiocyanate degradates and contain an ethyl group have been shown to exhibit fungicide properties (Al-Alam et al., Jour Chromat Sci. 4:429-435, 2017).

In another embodiment, soil fumigants other than those that liberate MITC or compounds that produce MITC as a degradate also may be useful in methods described herein. Such other compounds are effective to reduce the viability of a Fusarium organism (such as for instance Foc TR4) in treated soil when the soil fumigant is applied to soil to at least 40 cm below the soil surface, and/or distributed from 0 cm to at least 40 cm (or to at least 60 cm) below the soil surface. These other soil fumigants may generally be referred to as “Alternative Foc TR4 Fumigants”.

Examples of Alternative Foc TR4 Fumigants include for instance dimethyl disulfide, chloropicrin, 1,3-dichloropropene, 1,2-dichloropropane, and methyl bromide. The following table provides the corresponding structures:

| | |
|---|---|
| dimethyl disulfide | 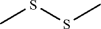 |
| chloropicrin | 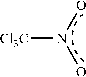 |
| 1,3-dichloropropene | 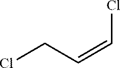 |
| 1,2-dichloropropane | 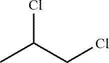 |
| methyl bromide | 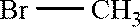 |

All of the embodiments and descriptions mentioned throughout this application apply, mutatis mutandis, to the Alternative Foc TR4 Fumigants. For example, the concentration, rate of application, and methods of application described herein apply to the Alternative Foc TR4 Fumigants.

### (VI) Optional Components in Formulations

In addition to the active component (that is, methyl isothiocyanate (MITC) or a compound that produces MITC as a degradate, or a functional equivalent thereof, such as an alternative Foc TR4 fumigant), formulations provided herein may include one or more additional ingredients. By way of example, these additional ingredients in one embodiment or in combination with any of the mentioned embodiments will include one or more of: active ingredient(s) (such as other pesticides, fertilizers, plant growth regulators and/or retardants, growth stimulators, flowering/fruiting inhibitors, harvest aids, defoliants, dehiscence inhibitors), rosins, adjuvants (such as emulsifiers, spreaders, stickers, drift control agents, rainfastness agents, surfactants, anti-caking agents, antifreeze agents, components to regulate respiration (water loss or gain)), and other additional optional ingredients (such as viscosity reducing agents, solubilizers, dispersal agents, anti-foamers, stabilizers, preservatives, antioxidants, pH regulators, sequestrants/chelators, solvents, additional polymers, odorants, and colorants or other markers, such as foam markers).

One of ordinary skill will recognize that individual active ingredients and other optional components are more (or less) readily included into different types of formulation(s). It is within ordinary skill to select which ingredient, or which form of an ingredient, to use in a selected formulation or for a certain use. Selection of one or more ingredients in any one formulation may be influenced for instance by the target application, the specific mode of application being employed, other component(s) in the formulation, the environment in which the formulation will be used, and so forth. Likewise, it is within the knowledge and ability of one of ordinary skill to determine, including through empirical study, appropriate amounts of each additional component in a formulation.

The formulations provided herein in one embodiment or in combination with any of the mentioned embodiments may optionally include one or more additional agrochemical active ingredient(s), in addition to the MITC or compound that produces MITC as a degradate (such as metam sodium), or a functional equivalent thereof (such as an alternative Foc TR4 fumigant). Generally speaking, such additional agrochemical active ingredient(s) can be any chemical or compound that has a selected biological activity. By way of example, active agents include chemicals, compounds, and mixtures that have one or more of acaricidal activity, bactericidal activity, fungicidal activity, herbicidal activity, insecticidal activity, larvicidal activity, nematocidal activity, miticidal activity, molluscicidal activity, piscicidal activity, rodenticidal activity, or slimicidal activity. Also contemplated are pest repellants. Additional active agents may include chemicals, compounds, or mixtures that modify, support, or enhance plant growth, such as a fertilizer, a hormone and/or other growth regulator. Additional active ingredients are listed herein. The following paragraphs provide non-exhaustive lists of contemplated agrochemical active ingredients.

Any of the formulations described herein may also optionally include one or more additional pesticides (beyond the MITC or a compound that produces MITC as a degradate, or functional equivalent or alternative, as described above) as active ingredients. Generally, pesticides are substances or a mixture of substances intended for destroying, repelling, inhibiting, or mitigating any unwanted pest(s), including particularly any organism that may have a negative impact on a crop. The term pesticide describes a broad category that includes acaricides (to eradicate ticks and mites), bactericides, additional fungicides, herbicides, insecticides, larvicides, miticides, molluscicides, nematicides, piscicides, rodenticides, and slimicides (anti-slime agents). The following paragraphs provide non-limiting, representative examples of various pesticides; additional examples, including biopesticide examples, will be recognized by those of ordinary skill in the art.

Algicides: Any of the formulations described herein may also optionally include one or more algicides as an active ingredient, which are used to mitigate the effects of algae damage on agricultural production. Useful algicides include bethoxazin, copper dioctanoate, copper sulfate, cybutryne, dichlone, dichlorophen, endothal, fentin, hydrated lime, nabam, quinoclamine, quinonamid, simazine, triphenyltin acetate, and triphenyltin hydroxide.

Bactericides: Any of the formulations described herein may also optionally include one or more bactericides as an active ingredient, which are used to mitigate the effects of bacterial damage or predation on agriculture. Useful bactericides include copper hydroxide, copper octanoate, copper oxychloride sulfate, copper sulfate, copper sulfate pentahydrate, kasugamycin, sodium hypochlorite, streptomycin sulfate.

Fungicides: Any of the formulations described herein may also optionally include one or more additional fungicide as an active ingredient, which are used to mitigate the effects of fungi damage or predation on agricultural production. It is noted that the first active ingredient described herein (that is, MITC or a compound that produces MITC as a degradate, or a functional equivalent thereof, such as an alternative Foc TR4 fumigant), is itself a fungicide. Useful secondary fungicides include azoxystrobin, trifloxystrobin, kresoxim methyl, famoxadone, metominostrobin and picoxystrobin, carbendazim, thiabendazole, dimethomorph, vinclozolin, iprodione, dithiocarbamate, imazalil, prochloraz, fluquinconazole, epoxiconazole, flutriafol, azaconazole, bitertanol, bromuconazole, cyproconazole, difenoconazole, hexaconazole, paclobutrazole, propiconazole, tebuconazole, triadimefon, triticonazole, fenpropimorph, tridemorph, fenpropidin, mancozeb, chlorothalonil, captafol, captan, folpet, fluazinam, flutolanil, carboxin, metalaxyl, bupirimate, ethirimol, dimoxystrobin, fluoxastrobin, orysastrobin, metominostrobin, prothioconazole, 8-(2,6-diethyl-4-methylphenyl)tetrahydropyrazolo [1,2-d][1,4,5]oxadiazepine-7,9-dione, 2,2,-dimethyl-propionic acid-8-(2,6-diethyl-4-methyl-phenyl)-9-oxo-1,2,4,5-tetrahydro-9H-pyrazolo-[1,2d][1,4,5]oxadiazepine-7-yl ester and metalaxyl.

Herbicides: Any of the formulations described herein may also optionally include one or more herbicides as an active ingredient, which are used to mitigate the effects of unwanted vegetation on agricultural production. Useful herbicides include fluzifop, mesotrione, fomesafen, tralkoxydim, napropamide, amitraz, propanil, cyprodanil, pyrimethanil, dicloran, tecnazene, toclofos methyl, flamprop M, 2,4-D, MCPA, mecoprop, clodinafop-propargyl, cyhalofop-butyl, diclofop methyl, haloxyfop, quizalofop-P, indol3-ylacetic acid, 1-naphthylacetic acid, isoxaben, tebutam, chlorthal dimethyl, benomyl, benfuresate, dicamba, dichlobenil, benazolin, triazoxide, fluazuron, teflubenzuron, phenmedipham, acetochlor, alachlor, metolachlor, pretilachlor, thenylchlor, alloxydim, butroxydim, clethodim, cyclodim, sethoxydim, tepraloxydim, pendimethalin, dinoterb, bifenox, oxyfluorfen, acifluorfen, fluoroglycofen-ethyl, bromoxynil, ioxynil, imazamethabenz-methyl, imazapyr, imazaquin, imazethapyr, imazapic, imazamox, flumioxazin, flumiclorac-pentyl, picloram, amodosulfuron, chlorsulfuron, nicosulfuron, rimsulfuron, triasulfuron, triallate, pebulate, prosulfocarb, molinate, atrazine, simazine, cyanazine, ametryn, prometryn, terbuthylazine, terbutryn, sulcotrione, isoproturon, linuron, fenuron, chlorotoluron, metoxuron, N-phosphonomethylglycine and its salts (glyphosate), glufosinate, chlormequat chloride, paraquat, diquat, trifloxysulfuron, fomesafen, mesotrione, fenuron, 2,2-dichloropropionic acid, amitrole, aminopyralid, asulam, aviglycine hydrochloride.

Insecticides: Any of the formulations described herein may also optionally include one or more insecticides as an active ingredient, which are used to mitigate the effects of insect damage or predation on agricultural production. Useful insecticides include abamectin, acephate, acetamiprid, acrinathrin, alanycarb, aldicarb, allethrin, alpha-cypermethrin, amitraz, azadirachtin, azamethiphos, azinphos-ethyl, azinphos-methyl, bendiocarb, benfuracarb, bensultap, beta-cyfluthrin, beta-cypermethrin, bifenthrin, bioallethrin, bioresmethrin, bistrifluron, borax, buprofezin, butoxycarboxim, cadusafos, carbaryl, carbofuran, chlorpropham, clothianidin, cyfluthrin, cyhalothrin, cyprmethrin, deltamethrin, diethofencarb, diflubenzuron, dinotefuran, emamectin, endosulfan, fenoxycarb, fenthion, fenvalerate, fipronil, halfenprox, heptachlor, hydramethylnon, imidacloprid, imiprothrin, isoprocarb, lambda cyhalothrin, methamidophos, methiocarb, methomyl, nitenpyram, omethoate, permethrin, pirimicarb, pirimiphos methyl, propoxur, tebufenozide, terpenes, thiamethoxam, thiodicarb, triflumoron, and xylylcarb.

Miticides: Any of the formulations described herein may also optionally include one or more miticides as an active ingredient, which are used to mitigate the effects of mite damage or predation on agricultural production. Useful miticides include antibiotic miticides, carbamate miticides, formamidine miticides, mite growth regulators, organochlorine, permethrin and organophosphate miticides.

Molluscicides: Any of the formulations described herein may also optionally include one or more molluscicides as an active ingredient, which are used to mitigate the effects of mollusk (e.g., slug or snail) damage or predation on agriculture. Usable molluscicides include metaldehyde, methiocarb and aluminum sulfate.

Nematicides: Any of the formulations described herein may also optionally include one or more nematicide as an active ingredient, which are used to mitigate the effects of nematode damage or predation on agriculture. Usable nematicides include: 1,3-dichloropropene, neem extracts, carbamates, garlic-derived polysulfides, marigold (Tagetes) extracts, and so forth.

Another category of active ingredient that may optionally be included in one embodiment or in combination with any of the mentioned embodiments of the provided agricultural formulations and compositions is fertilizers. Thus, any of the formulations described herein may also optionally include one or more fertilizers as active ingredient(s). Fertilizers are natural or artificial substances that include one or more chemical elements that improve growth and productiveness of plants. Fertilizers enhance the natural fertility of a growth medium (such as soil) or replace the chemical elements taken from the growth medium by previous crops. Modern chemical fertilizers include one or more of the three elements that are most important (main macronutrients) in plant nutrition: nitrogen (N; particularly useful for leaf growth), phosphorus (P; particularly useful for development of roots, flowers, seeds, and fruit), and potassium (K; beneficial for strong stem growth, movement of water in plants, and promotion of flowering and fruiting). Of secondary importance are the elements sulfur (S), magnesium (Mg), and calcium (Ca) (referred to as secondary macronutrients). Optionally, fertilizers may include one or more micronutrients: copper (Cu), iron (Fe), manganese (Mn), molybdenum (Mo), zinc (Zn), boron (B). Of occasional significance are silicon (Si), cobalt (Co), and vanadium (V).

Nitrogen fertilizers may be obtained from synthetic ammonia (NH₃); this chemical compound is used either as a gas or in a water solution, or it is converted into salts such as ammonium sulfate, ammonium nitrate, and ammonium phosphate. Ammonium can also be made from waste streams, such as packinghouse wastes, treated garbage, sewage, and manure. Phosphorus fertilizers include calcium phosphate derived from phosphate rock or bones. The more soluble superphosphate and triple superphosphate preparations are obtained by the treatment of calcium phosphate with sulfuric and phosphoric acid, respectively. Potassium fertilizers, namely potassium chloride and potassium sulfate, are mined from potash deposits. Mixed fertilizers contain more than one of the three major nutrients-nitrogen, phosphorus, and potassium. Mixed fertilizers can be formulated in myriad ways, which are well known to those of ordinary skill in the art.

Particularly contemplated herein are fertilizer compositions and formulations intended to be applied as liquids. Examples of liquid fertilizers include one or more of aqueous solutions of ammonia, aqueous solutions of ammonium nitrate, or urea; these concentrated nitrogenous products may be diluted with water to form a concentrated liquid fertilizer (e.g., UAN). Advantages of liquid fertilizer are its more rapid effect and easier coverage.

In i one embodiment or in combination with any of the mentioned embodiments, it may be beneficial to include one or more agriculturally acceptable adjuvant(s), to influence one or more characteristics of the formulation. One of ordinary skill will recognize adjuvants that can be used with the provided formulations. The following paragraphs provide example adjuvant categories as well as specific example adjuvants; these lists are not intended to be exhaustive.

Any of the formulations described herein may also optionally include one or more emulsifiers. One of ordinary skill will recognize that there are many agriculturally acceptable emulsifiers available, which may be useful in one embodiment or in combination with any of the mentioned embodiments of the current disclosure. By way of example, emulsifiers may include: alkanoic and alkenoic acids, monoesters and diesters of α-hydro-ω-hydroxypoly (oxyethylene), glyceryl monostearate, and/or sodium metasilicate.

Any of the formulations described herein may also optionally include one or more spreaders. One of ordinary skill will recognize that there are several agriculturally acceptable spreader/wetter compounds available, which may be useful in one embodiment or in combination with any of the mentioned embodiments of the current disclosure. By way of example, spreaders may include: Alkyl Aryl Polyethoxy Ethers and other Ethoxylated derivatives, Fatty Acid, Isopropanol.

Any of the formulations described herein may also optionally include one or more sticking agents (stickers). One of ordinary skill will recognize that there are several agriculturally acceptable stickers available, which may be useful in one embodiment or in combination with any of the mentioned embodiments of the current disclosure. Examples of sticking agents include latex based products, pinolene/terpene-based products, and long chain polysaccharides like gellan gum, guar gum and xanthan gum. Alternatively, the sticking agent may be a polymer or co-polymer from a type of polymer such as polyacrylate and polyethylene, or a polyether amide, or imide.

Any of the formulations described herein may also optionally include one or more drift control agents, particularly in embodiments wherein the formulation is applied at or near the surface of the soil. One of ordinary skill will recognize that there are many agriculturally acceptable drift control agents available, which may be useful in one embodiment or in combination with any of the mentioned embodiments of the current disclosure. Examples of drift control agents include: lecithin and related derivatives, linear nonionic polymers with a molecular weight of at least 20 kDa, guar gum and its derivatives, and fatty alcohol alkoxylates.

Suitable lecithin derivatives are lecithin and its chemically modified derivatives. Such drift control agents are for example commercially available as LIBERATE® or COMPADRE® from Loveland Products.

Typical polymers currently utilized as drift control agents include visco-elastic polyacrylamides, polyethylene oxides, and poly (vinyl pyrrolidones), with polyacrylamides being an agriculture industry spray tank additive, drift reduction standard. Suitable linear nonionic polymers with a molecular weight of at least 20 kDa, may be selected from polyacrylamide, polyacrylate, or a polyethylene glycol. Also considered are nonionic polymers, such as polyacrylamide and polyacrylate. The molecular weight of such nonionic polymers is in one embodiment or in combination with any of the mentioned embodiments, at least 50 kDa, for instance at least 100 kDa, and in particular examples at least 1000 kDa.

Suitable guar gums include for example those described in EP0660999, or are commercially available as AGRHO® DEP 775 or AGRHO® DR 200 from Rhodia. Hydroxy propyl guar and carboxymethyl hydroxy propyl guar are also examples.

Example fatty alcohol alkoxylates include fatty alcohol ethoxylates. The fatty alcohol may comprise a C8-22, or a C14-20, and in representative instances a C16-18 fatty alcohol. The fatty alcohol ethoxylate may comprise from 1 to 15, for instance from 1 to 8, and in certain examples from 2 to 6 equivalents of ethylene oxide. A suitable fatty alcohol ethoxylate is a C14-20 fatty alcohol, which includes from 2 to 6 equivalents of ethylene oxide. The drift control agent may have a hydrophile-lipophile balance (HLB) value of 4.0 to 11.0, for instance of 6.0 to 10.0 and in certain examples of 8.0 to 10.0. In another particular form the drift control agent has a HLB of 5.0 to 8.0, and for instance from 6.0 to 7.0. The HLB may be determined according to Griffin’s Method (Griffin, J Soc Cosmet Chem. 1(5):311-326, 1949). In another exemplar form, the drift control agent is a fatty alcohol alkoxylate.

Also contemplated for use as drift control agents are Hydroxyethyl cellulose (HEC), ethyl Hydroxyethyl cellulose (EHEC), hydroxylpropyl cellulose (HPC), hydroxybutyl methylcellulose (HBMC), hydroxypropyl methylcellulose (HPMC), methyl ethyl hydroxyethyl cellulose (MEHEC), and hydrophobically modified ethyl hydroxyethyl cellulose (HMEHEC).

Any of the formulations described herein may also optionally include one or more surfactants. One of ordinary skill will recognize that there are several agriculturally acceptable surfactants available, which may be useful in one embodiment or in combination with any of the mentioned embodiments of the current disclosure. Surfactants may include one or more of: a-(nonylphenyl)-oo-hydroxypoly(oxy-1,2-ethanediyl); polyethyleneglycol ether; mono(nonyl phenyl)ether; macrogol nonylphenyl ether; polyoxyethylene(n)-nonylphenyl ether; nonylphenyl polyethylene glycol ether; nonylphenoxypolyethoxyethanol; and poly(oxy-1,2 ethanediyl)-a-(nonphyenol)-)-hydroxy, N-alkyl-N,N-dimethylammonium glycinates, for example cocoalkyldimethyl-ammonium glycinate, N-acylaminopropyl-N,N-dimethylammonium glycinates, for example cocoacylaminopropyldimethyl-ammonium glycinate, and 2-alkyl-3-carboxylmethyl-3-hydroxyethyl-imidazolines with in each case 8 to 18 C atoms in the alkyl or acyl group, and cocoacylaminoethylhydroxyethylcarboxymethyl glycinate, N-alkylglycines, N-alky Ipropionic acids, N-alkylaminobutyric acids, N-alkylimino dipropionic acids, N-hydroxyethyl-N-alkylamidopropylglycines, N-alkyltaurines, N-alkylsarcosines, 2-alkylamino propionic acids and alkylaminoacetic acids with in each case approximately 8 to 18 C atoms in the alkyl group. Exemplary ampholytic surfactants include N-cocoalkyl amino propionate, coco acyl aminoethyl amino propionate, and C-C-acylsarcosine.

Non-ionic surfactants include alkoxylates, such as alkoxylated alcohols, alkoxylated fatty acids, for instance ethoxylates and their derivatives including ethoxylated C8 to C24 saturated and unsaturated, linear and branched fatty acids or fatty alcohols, alkoxylated block copolymers, alkoxylated arylalkylphenols, especially ethoxylates and their derivates including alkylphenolethoxylates, alkoxylated amines, alkoxylated oils, fatty esters, especially polyethyleneglycol mono- and diesters of C8 to C24 saturated and unsaturated, linear and branched fatty acids, sorbitan derivatives including esters and ethoxylates, alkylpolyglucosides, and the like.

Ionic surfactants include alkylarylsulfonates, alkylarylsulfonic acids, carboxylated alcohol ethoxylates and alkylphenol ethoxylates, carboxylic acids/fatty acids, diphenylsulfonate derivatives, olefin sulfonates, phosphate esters, phosphorous organic derivatives, quaternary surfactants, sulfates and sulfonates of oils and fatty acids, sulfates and sulfonates of ethoxylated alkylphenols, sulfates of exthoxylated alcohols , sulfates of fatty acids, sulfonates of dodecyl and tridecylbenzenes, sulfonates of naphthalene and alkylnaphthalene, sulfonates of petroleum, sulfosuccinamates, alkanolamides, alkoxylated amines, N-acylsarocinates and the like.

Any of the formulations described herein, and particularly the dry or powder-based formulations, may also optionally include one or more anti-caking agents. One of ordinary skill will recognize that there are several agriculturally acceptable anti-caking agents available, which may be useful in one embodiment or in combination with any of the mentioned embodiments of the current disclosure. Anti-caking agents may include sodium carbonate, tricalcium phosphate, potassium carbonate, ammonium carbonate, magnesium carbonate, hydrochloric acid, potassium chloride, calcium chloride, ammonium chloride, magnesium chloride, stannous chloride, sulfuric acid, sodium sulphates, potassium sulphate, calcium sulphate, ammonium sulphate, magnesium sulphate, Epsom salts, copper sulphate, aluminum sulphate, aluminum sodium sulphate, aluminum potassium sulphate, aluminum ammonium sulphate, sodium hydroxide, potassium hydroxide, calcium hydroxide, ammonium hydroxide, magnesium hydroxide, calcium oxide, magnesium oxide, sodium ferrocyanide, potassium ferrocyanide, calcium ferrocyanide, dicalcium diphosphate, sodium aluminum phosphate, sodium silicate, silicon dioxide, calcium silicate, magnesium silicate, magnesium trisilicate, talc, sodium aluminum silicate, potassium aluminum silicate, aluminum calcium silicate, bentonite, kaolin, stearic acid, magnesium stearate, calcium stearate, gluconic acid, glucono delta-lactone (gluconolactone), sodium gluconate, potassium gluconate, calcium gluconate, ferrous gluconate, ferrous lactate, polydimethylsiloxane.

Optionally, the formulations and compositions described herein may include one or more additional agriculturally acceptable ingredients. The following provides representative examples of categories of optional ingredients; the lists provided herein are not intended to be exhaustive, but instead merely provide examples.

Any of the formulations described herein may also optionally include one or more viscosity reducing agents. Viscosity reducing agents may include: glycerol, ethylene glycol, propylene glycol and low molecular weight polyethylene or polypropylene glycols.

Any of the formulations described herein may also optionally include one or more solubilizers. Solubilizers may include: sodium p-toluenesulfonate and sodium xylene sulfonate.

Any of the formulations described herein may also optionally include one or more anti-foaming agents. Anti-foamers are useful in order to prevent or reduce foam that can arise during formulation or upon dilution. One of ordinary skill will recognize that there are several agriculturally acceptable anti-foamer agents available, which may be useful in one embodiment or in combination with any of the mentioned embodiments of the current disclosure. Anti-foamer agents may include: 20 polyethylene glycol 8000, polymethylsiloxane, simethicone octanol, and silicone oils and emulsions.

Any of the formulations described herein may also optionally include one or more stabilizers (stabilizing agents). One of ordinary skill will recognize that there are several agriculturally acceptable stabilizers available, which may be useful in one embodiment or in combination with any of the mentioned embodiments of the current disclosure. Stabilizers include: xanthan gum, agar, alginic acid, alginate, calcium lactobionate, carrageenan, gellan gum, guar gum, diisopropanolamine, hydroxyethylidene diphosphonic acid, and silver nitrate.

Any of the formulations described herein may also optionally include one or more preservatives. One of ordinary skill will recognize that there are several agriculturally acceptable preservatives available, which may be useful in one embodiment or in combination with any of the mentioned embodiments of the current disclosure. Preservatives may include weak acid preservatives such as sorbic acid, lactic acid, benzoic acid, propionic acid, citric acid, acetic acid, or an alkali metal or alkali earth metal salt thereof; inorganic acids such as hydrochloric acid; imidazoles such as imazalil. More generally, a “preservative component” if included in the composition is any molecule that can be used to increase the field or shelf life of the formulation.

The preservative component can be included in the formulation at any concentration that is sufficient to increase shelf life. Generally, shelf life refers to the amount of time that a particular formulation can be maintained in saleable condition.

One of ordinary skill in the art will be able to determine the appropriate concentration of preservative component(s), for instance desired by producing test formulations having varying amounts of preservative components, and measuring the self-life or field life of the formulation. Exemplary concentrations of preservative components in the compositions include from 0.001% to 10.5%, from 0.01% to 10%, from 0.02% to 9%, from 0.05% to 8%, from 0.07% to 7%, from 0.10% to 6%, and from 0.15% to 5%. The preservative component, if included in the composition, may in addition increase the shelf-life of the formulation during storage, shipping, exhibiting for sale and handling that may happen prior to use of the product by the end user for the uses outlined herein for the compositions detailed in the current document.

In additional examples, antioxidants can be included in the compositions and formulations provided herein. Antioxidants can be used to protect certain active ingredients from degradation due to contact with oxygen. Exemplary antioxidants include EDTA, glutathione, α-tocopherol, tocopherols, vitamin E, vitamin E acetate, vitamin E palmitate, zinc glycinate, ascorbic acid and its salts of calcium, sodium, and potassium, ascorbyl palmitate, calcium citrate, BHA, BHT, guaiac extract, gallic acid and methyl, ethyl, propyl, dodecyl esters of gallic acid, phosphatidylcholine, propionic acid, sucrose, cyclodextrins, rosemary, and cysteine hydrochloride. Additional antioxidants include amino acids (e.g. glycine, histidine, tyrosine, tryptophan) and their derivatives, imidazole (e.g. urocanic acid) and derivatives, vitamin C and derivatives (such as ascorbylpalmitate and ascorbyltetraisopalmitate, Mg-ascorbylphosphate, Naascorbylphosphate, ascorbyl-acetate), tocopherol and derivates (such as vitamin E- acetate), mixtures of vitamin E, vitamin A and derivatives (vitamin-A, palmitate and acetate) as well as coniferyl benzoate, rutinic acid and derivatives, α-glycosylrutin, ferulic acid, furfurylideneglucitol, carnosine, 15 butylhydroxytoluene, butylhydroxyanisole, and trihydroxybutyrophenone. In one embodiment or in combination with any of the mentioned embodiments, antioxidants can be included at a concentration of from 0.01 to 1.0%. A composition or formulation may include a combination of two or more different antioxidants.

Any of the formulations described herein may also optionally include one or more compounds that influence or regulate pH, for instance, buffers, acidifiers, basifiers, and so forth. One of ordinary skill will recognize that there are several agriculturally acceptable pH regulating compounds available, which may be useful in one embodiment or in combination with any of the mentioned embodiments of the current disclosure. Examples of pH regulators include: ethanolamine, phosphoric acid, triethanolamine, acetic acid, diethylamine, monoethylamine, and monoisopropylamine.

Any of the formulations described herein may optionally include one or more sequestrants or chelators, for instance in order to regulate the amount of metals suspended in a formulation. The term “sequestrant” refers to a compound that is capable of removing or inactivating another substance through chelation. A chelant (or chelating agent) is thus a more general term than sequestrant. Examples of sequestrants include those used to complex metal ions (e.g. EDTA or gluconate). On the other hand, chelants might be used more widely, for example assaying metal ion concentrations colorimetrically (e.g. neocuproine), or forming compounds that are very important/useful in their own right (e.g. chlorophyll, copper phthalocyanine). A sequestrant might thus be expected to complex several varieties of ion if present, whereas certain application of a chelant might involve intentional chelation with just one type of ion.

One of ordinary skill will recognize that there are several agriculturally acceptable chelants and sequestrants available, which may be useful in one embodiment or in combination with any of the mentioned embodiments of the current disclosure. Examples of chelants include Na-polyphosphates, Na-polyacrylates, Na-lignosulfonates, citric acid, Na-Citrate, Na gluconate/ glucoheptonate, EDTA, disodium salts, and diammonium salts.

It is recognized, for instance, that well water often has a high concentration of Ca⁺⁺ ions. This can result in the formation of gels, precipitates, or solids during preparation or dilution of an agrochemical formulation. For instance, in locations or regions where water is particularly hard, it may be useful to either use softened water (such as can be provided by an in-line water softener), or to add chelating agent(s) that sequester the Ca⁺⁺ ions. Optionally, such chelating agent(s) may be tank mix agents, for instance agents that are formulated to account for region-specific water hardness.

It is recognized in the art that water hardness is a measure of the amount of salt that is present in water and is typically expressed in milligrams of dissolved calcium and magnesium carbonate per liter of water. Water hardness varies greatly between agricultural sites and regions and is recognized by a person having ordinary skill in the art to affect the biophysical (e.g., specific gravity, evaporation rate) and chemical properties (e.g., pH, ionic strength) of a solution, including solutions used in agriculture. For example, in solutions that include MITC or a compound that produces MITC as a degradate (or a functional equivalent thereof, such as an alternative Foc TR4 fumigant), water hardness can alter precipitation rates and pH and effect the solubility of pesticides as well as alter the sprayability of a solution. It is also recognized by a person having ordinary skill in the art that the changes in biophysical and chemical properties of a solution that arise due to water hardness impact the efficacy of common pesticides. For example, reducing water hardness is recognized by a persona having ordinary skill in the art to reduce the phytotoxicity of glyphosate. Water hardness is often addressed through myriad ways, which include, but are not limited to using water softeners in a water line (e.g., replacing calcium with sodium) or adding chelating agents (e.g., EDTA, citric acid) in a holding tank.

Any of the formulations described herein may also optionally include one or more polymers. For instance, polymers may include: semi-synthetic polymer substances such as a sulfopolymer, diethylaminoethyl (DEAE) cellulose, nitrocellulose, carboxymethyl cellulose, quaternary amine substituted cellulose, and phosphonic and sulfonic acid derivatized celluloses. Such polymers may be prepared from common and inexpensive, large scale materials including: cellulose, dextran, ethylene glycol, polyethyleneimine, vinyls, acetates, amides and so on.

Any of the formulations described herein may also optionally include one or more odorants, for instance in order to mask the aroma of other components in the formulation or to provide a scent identifier or marker. One of ordinary skill will recognize that there are myriad agriculturally acceptable odorants available, which may be useful in one embodiment or in combination with any of the mentioned embodiments of the current disclosure. A non-exhaustive list of odorants can be found, for instance, in U.S. Pat. Publication No. 2009/0163449.

Any of the formulations described herein may also optionally include one or more colorants, for instance in order to provide product identification and anti-counterfeiting, and to identify specific products for health and safety reasons. Colorants can also be used to reveal where an otherwise largely transparent formulation has been applied, for instance to ensure complete coverage with minimal duplicative coverage. One of ordinary skill will recognize that there are several agriculturally acceptable colorants available, which may be useful in one embodiment or in combination with any of the mentioned embodiments of the current disclosure. Representative example colorants include FD&C Blue No. 1, FD&C Red No. 40, for instance, as well as proprietary colorants available from Pylam Dyes (Tempe, AZ), Vipul Organics Ltd. (Mumbai, India), and other commercial producers.

### (VII) Methods of Making Formulations

The formulations, including concentrate formulations, referred to herein in general can be made in conventional ways. Representative methods for making formulations, including concentrate formulations, are provided herein. In one embodiment or in combination with any of the mentioned embodiments, the ingredients of a desired formulation may simply be mixed together - often all at the same time, optionally using moderate to high-shear mixing.

In one embodiment or in combination with any of the mentioned embodiments, the MITC or compound that produce MITC is applied in essentially pure form, or optionally mixed or diluted with water to the desired application concentration.

In one embodiment or in combination with any of the mentioned embodiments, where the compound that produces MITC is applied as a solid, granular, or powder form, it may be applied directly or mixed with one or more other solid/granular/powdered ingredients. Such mixing can be carried out using conventional and art-recognized means.

### (VIII) Uses of Formulations

The formulations and methods provided herein can be used to treat banana and/or Musa fields in order to reduce the level of viable fungal propagules, for instance viable Fusarium cells (including spores), such as Foc TR4. The formulations and methods enable the treatment of soil with a composition comprising methyl isothiocyanate (MITC) or a compound that produces MITC as a degradate, or a functional equivalent thereof, such as an alternative Foc TR4 fumigant. The composition or compound may include at least one of metam sodium, metam potassium, metam-ammonium, dazomet, or other compounds that produce MITC as a degradate, or a functional equivalent thereof, such as an alternative Foc TR4 fumigant. The composition or compounds may be applied to soil at least two depths between 0 and 60 cm below the soil surface. During application, at least one depth is at least 40 cm below the soil surface and a second depth is between 0 and 40 cm below the surface.

The composition may be put into solution wherein the liquid portion of the solution is water and the concentration of the solution is desirably at least 100, or at least 150, or at least 200, or at least 250 or at least 300, or at least 350, or at least 400, or at least 450, or at least 500 grams of methyldithiocarbamate equivalents per liter of solution. The upper amount is not limited except by what is practical to avoid wasting the active compound. Desirably, the upper amount is up to 1300, or up to 1100, or up to 1000, or up to 900, or up to 850, or up to 800, or up to 750, or up to 700, or up to 650, or up to 600, or up to 550, or up to 500, or up to 450, or up to 400 grams of methyldithiocarbamate equivalents per liter of solution. The methyldithiocarbamate equivalents may be metam-sodium, metam-potassium, metam-ammonium, dazomet, or other compounds that produce MITC as a degradate, or a functional equivalent thereof, such as an alternative Foc TR4 fumigant. The composition may also comprise surfactant, a spreading agent, a wetting agent, an emulsifier, a thickening agent, a sticking agents, a penetrating agent, a humectant, a dispersing agent, an antifoaming agent, a compatibility agent, a micronutrient, a preservative, a solvent, a colorant, a fragrance, or a combination of two or more thereof. The composition may also include N-octyl pyrrolidone (NOP), Xiameter, Soprophor, Ethilformate, or two or more thereof.

The application of the composition to the soil may occur at a rate between 500 and 5,000 liters per hectare at any of the above-mentioned concentrations, or at a concentration at least 200 and up to 1000 grams, or 300 to 700 grams of methyldithiocarbamate equivalents per liter of solution. The humidity of the soil influences the conversion of certain compositions to MITC, which are driven by water concentration dependent hydrolysis reactions. As such, the water holding capacity of the soil is influential to the application process. Soil is at 40 to 80% water holding capacity prior to the application of the composition in one embodiment or in combination with any of the mentioned embodiments, though higher and lower moisture levels are also applicable. Optionally, the soil can be wetted before application, for instance if a higher moisture level is desired.

The composition is applied to the soil after the soil has been prepared. Preparing the soil prior to application in one embodiment or in combination with any of the mentioned embodiments includes tilling or otherwise physically disrupting the soil in order to break the soil structure from 0 to 80 cm deep, or from 0 to 60 cm deep below the soil surface. This may be accomplished by digging, stirring, overturning, shoveling, picking, mattock work, hoeing, raking, rototilling, plowing, rolling, harrowing, cultivating, or any combination thereof. The broken soil must then be leveled, which can be accomplished leveling can be done manually or via machinery with corresponding equipment. Manual leveling may be performed on smaller plots of land with hoes, or with draft animals and equipment such as ploughs and bars, or scrapers. Machinery such as tractors may be used in conjunction with grading blades, hydraulically operated levelers, or buckets.

The application of the composition to the soil may occur by injection application using shank/chisel blade drawn by a tractor or other motorized machine. The injection application may occur using a goose foot blade drawn by a tractor or other motorized machine. After injection the soil may be left intact, or it may be mixed to distribute the composition. The mixing may be accomplished using rotary blades to incorporate/distribute the composition through the soil column. If the soil is blended, this may occur immediately after the composition is applied to the soil, or up to 3 hours after the composition is applied to the soil.

The soil may also be sealed after application. Sealing the soil may include covering the soil with an impermeable or semi-permeable cover/tarp, mechanically compacting the soil (e.g., with a bed-shaper, roller, press wheel, coil packer, ring packer, or similar device), covering the treated soil with a layer of untreated soil (e.g., 7-15 cm of untreated soil), and/or irrigating the soil (for instance, with a minimum of 0.5 cm of water beginning immediately after application of the treatment begins). This may occur immediately after the soil is treated, or between one minute and 60 minutes after the soil is treated. If a covering (such as a tarp) is used to seal the treated soil, that covering will be left in place for a period of at least 12 hours, at least 24 hours, at least 2 days, at least 3 days, at least 4 days, at least 5 days, or more than 5 days. Removal of such a covering includes complete removal as well as partial remove or perforation, for instance perforation with the intention of planting through the covering.

In one embodiment, or in combination with any of the mentioned embodiments, after application, the composition and/or degradate(s) thereof are distributed throughout the soil depth at an amount of at least 0.5 g/m², or at least 1 g/m², or at least 3 g/m², or at least 10 g/m², in each case grams/square meter of treated soil, measured at a depth anywhere between 60 cm to 20 cm below the surface using the average of six sampling points evenly distributed across the area. The upper amount is not particularly limited, but it is sufficient to effectively treat the Foc TR4 at a concentration of 100 g/m² or less, or 153 g/m² or less, or 250 g/m² or less, in each case grams/square meter of treated soil, measured at a depth of 40 cm using the average of six sampling points evenly distributed across the area. The final concentration can vary within this range based on the humidity, soil type, and temperature. For instance, the final concentration can be roughly 0.5 g/m² to 500 g/m², 1 g/m² to 500 g/m², 2 g/m² to 500 g/m², 5 g/m² to 500 g/m², 7 g/m² to 500 g/m², 0.5 g/m² to 200 g/m², 1 g/m² to 200 g/m², 2 g/m² to 200 g/m², 5 g/m² to 200 g/m², 7 g/m² to 200 g/m², 0.5 g/m² to 153 g/m², 1 g/m² to 153 g/m², 2 g/m² to 153 g/m², 5 g/m² to 153 g/m², 7 g/m² to 153 g/m², 0.5 g/m² to 100 g/m², 1 g/m² to 100 g/m², 2 g/m² to 100 g/m², 5 g/m² to 100 g/m², or 7 g/m² to 100 g/m².

In one embodiment, or in combination with any of the mentioned embodiments, after application, the composition and/or degradate(s) thereof are distributed throughout the soil depth at an amount of at least 0.5 g/m², or at least 1 g/m², or at least 3 g/m², or at least 10 g/m², in each case grams/square meter of treated soil, measured at a depth anywhere between 70 cm to 20 cm below the surface using the average of six sampling points evenly distributed across the area, where at least one of the six sample points is taken at 60 cm and at least one is taken at 30 cm. The upper amount is not particularly limited, but it is sufficient to effectively treat the Foc TR4 at a concentration of 100 g/m² or less, or 153 g/m² or less, or 250 g/m² or less, in each case grams/square meter of treated soil, measured at a depth of 50 cm, or 40 cm, or 30 cm, or a combination of two or more depths between 60 and 20 cm, using the average of six sampling points evenly distributed across the area. The final concentration can vary within this range based on the humidity, soil type, and temperature.

The application of the composition to the soil reduces viable Fusarium propagule count, such as specifically Foc TR4 propagules. The reduction in soil of Foc TR4 propagule count is generally more than 5%, and in one embodiment or in combination with any of the mentioned embodiments it is at least more than: 10%, 15%, 20%, 25%, 30%, 40%, 50%, 60%, 70%, or more, when compared to the Foc TR4 propagule count in the soil before treatment. The reduction in soil Foc TR4 propagule count can be more than 75% when compared to the soil before treatment.

One or more banana plants, or other Musa plants are planted in the treated soil after the soil is treated with the composition. The plant(s) are planted in the soil on at least one of the following planting schedules: three days after treatment, five days after treatment, seven days after treatment, 10 days after treatment, 12 days after treatment, 14 days after treatment, or more than 14 days after treatment.

More generally, methods and techniques for soil fumigant application, safety, and management are known in the art. See, for instance, the NASDARF Soil Fumigation Manual published by the National Association of State Departments of Agriculture Research Foundation, 2012 (available online at s3.amazonaws.com/nasda2/media/Pages/Fumigation_lo.pdf? mtime=20171025135626).

### Methods of Diluting Concentrate Formulations

There are provided herein formulations that are concentrates – that is, formulations that contain the active ingredient (MITC or a compound that produces MITC as a degradate (such as metam sodium), or a functional equivalent thereof, such as an alternative Foc TR4 fumigant) at level higher than the as-applied level of that ingredient – which concentrates are intended to be diluted before application or use. Concentrates are recognized as beneficial, for instance because they can be more efficiently stored (since they take up less volume than a diluted formulation), they are in various instances more stable for long-term storage or shipment, and so forth. However, it is important that concentrate formulations are diluted before use in order to avoid waste, to avoid toxicity that may result from using active ingredient(s) or other components at a higher level than recommended, to avoid phytotoxicity or other adverse biological effects arising from mis-balanced formulation components, and to avoid environmental contamination and/or user health impacts. The art recognizes methods for diluting concentrate formulations; the following discussion is provided for guidance only, and is not intended to be limiting.

Concentrated formulations may be diluted by adding a desired quantity of the concentrate formulation (generically, a stock solution) to an amount of diluent/solvent (such as, for example, water). The resulting solution contains the amount of components originally taken from the concentrate formulation (stock solution), but dispersed throughout a greater volume. Therefore, the final concentration of solvent(s) is lower; the final solution (for instance, an as-applied formulation) is less concentrated and more dilute.

There are many ways of expressing concentrates and dilution. The following, while not intended to be an exhaustive list, describes exemplary ways of expressing concentrates and dilutions.

Using CrVr = C₂V₂: To make a fixed amount of a dilute solution from a stock solution, the following formula may be used:
C₁V₁ ₌ C₂V₂
where:
   V₁ = Volume of stock solution needed to make the new solution
   C₁ = Concentration of stock solution
   V₂ = Final volume of new solution
   C₂ = Final concentration of new solution
   Using Dilution Factors: To make a dilute solution without calculating concentrations, the derivation of the above formula may be used (can also be used with mass):
(Final Volume / Concentrate Volume) = Dilution Factor.

The dilution factor (DF) can be used alone or as the denominator of the fraction, for example, a DF of 10 means a 1:10 dilution, or 1-part concentrate + 9 parts diluent, for a total of 10 parts. This is different from a “dilution ratio,” which typically refers to a ratio of the parts of solute to the parts of solvent, for example, a 1:9 using the previous example. Dilution factors are related to dilution ratios in that the DF equals the parts of solvent + 1 part.

Step Dilutions: If the dilution factor is larger than the final volume needed, or the amount of concentrate stock is too small to be readily measured and dispensed, one or more intermediary dilutions may be required. The formula Final DF = DF₁ * DF₂ * DF₃ etc., may be used, until the product reaches the appropriate final dilution.

Concentrates may be produced in a wide range of viscosities, from non-flowable, viscous concentrates to less viscous, flowable concentrates. Moreover, dilutions of such concentrates may be prepared by any of the above or other known methods, generally by measuring and dispensing the desired amount of concentrate into a mixing vessel or container that contains or to which is then added the desired diluent (such as water). More viscous concentrates may be measured, for example, by scooping portions of the concentrate into a measuring vessel until the desired amount of concentrate has been deposited into the measuring vessel and emptying, via a scooping or spatula-like utensil, the measured contrate from the measuring container into the mixing vessel or container. Alternatively, a desired amount of concentrate may be directly deposited into a mixing vessel through squeezing or cutting a desired amount of the concentrate into the mixing vessel or container. Less viscous, flowable, concentrates may be measured by simply pouring or otherwise depositing a measured, desired amount of the concentrate into the mixing vessel or container. Water or other diluent/solvent may then be added until the desired dilution concentration (for instance, the as-applied concentration) is achieved. Optionally, the concentrate/solvent mixture may be, for example, agitated and/or heated to aid in the dissolution of the concentrate wherein more agitation or heat may be required for more viscous concentrates. In one embodiment or in combination with any of the mentioned embodiments, the only agitation that is required is provided by the jostling of a tank or container holding the diluted formulation as it is transported to the application site(s).

Also contemplated are embodiments in which the concentrate formulation is provided in a pre-measured amount, for instance an amount appropriate for dilution to the desired (e.g., as-applied) concentration in a set final volume. For instance, a concentrate formulation intended to be diluted 1 :1000 in water may be provided as a 1-gallon, pre-measured container that is mixed into a 1000-gallon container with water.

Further, in all of the dilution embodiments it is understood that the amount of diluent used may be reduced by the volume of other mix components (such as adjuvants, for instance tank mix adjuvants) that are to be added to the final as-applied formulation. Providing for inclusion of such tank mix adjuvants in a final, as-applied (diluted) formulation is within the scope of ordinary skill.

### Soil Preparation

To provide the best and most effective levels of anti-fungal activity, the soil is tilled or otherwise disrupted physically to break the soil structure (e.g., decompaction) from 0 to 80 cm deep, or from 0 to 60 cm deep, before the active compound is applied. Rototilling is efficacious in breaking the soil structure, but soil can be tilled by various approaches, including but not limited to digging, stirring, overturning, shoveling, picking, mattock work, hoeing, raking, rototilling, plowing, rolling, harrowing, cultivating, subsoiling, ripping, or any combination thereof. Techniques for breaking up compacted subsoil layers are known in the art; see, for instance, “Using Subsoiling to Reduce Soil Compaction”, 2008 USDA Publication 0834-2828-MTDC (available online at fs.fed.us/t-d/pubs/pdfpubs/pdf08342828/ pdf08342828dpi72.pdf).

In operating cultivators or tillers, the shanks tend to leave furrows directly behind the shank, with ridges on opposite sides thereof. Such furrows in many cases form runoff channels for water and may result in a serious increase in erosion of the soil and inadequate distribution of the MITC or compound that produces MITC as a degradate (such as metam sodium), or a functional equivalent thereof (such as an alternative Foc TR4 fumigant). In addition, the furrows and ridges make application extremely difficult not only by causing bouncing of the tractor or cultivator, but by making it difficult to maintain the shoe at a uniform depth. As such, soil beneficially is leveled and uniform before application, so that the machine and tractor can advance at matching paces in all soil in which injection of formulation will take place. Soil leveling can be done manually or via machinery with corresponding equipment. Manual leveling may be performed on smaller plots of land with hoes, or with draft animals and equipment such as ploughs and bars, or scrapers. Machinery such as tractors may be used in conjunction with grading blades, hydraulically operated levelers, or buckets.

Soil humidity affects the conversion of degradation of certain active ingredients (such as metam sodium) to MITC, and soil humidity is optimally between 50% and 60% holding capacity. Prior to application of the active formulation, soil humidity may be measured and additional water added if needed to reach between 50% and 60% of the water holding capacity of the soil. Water may be added to the soil through a variety of irrigation methods. Surface irrigation may be used to add water at the surface level and infiltrate into the soil. Micro-irrigation may also be used to distribute water under low pressure through a piped network and applied in small amounts throughout a field. The distribution via micro-irrigation may occur through the use of individual emitters, subsurface drip irrigation, micro sprayers, micro-sprinklers, and mini-bubbler irrigation. Drip irrigation may be used to deliver water in specific locations and spot treat water to reach desired humidity at specific locations. Sprinkler irrigation can be used to treat large portions of a field. Sprinkler irrigation involves piping water to one or more central locations within a field and distributing by overhead high-pressure sprinklers or guns. Sprinkler irrigation may also utilize a central pivot, wherein the sprinkler moves in a circular pattern and is fed with water from the pivot point at the center and arcs outward.

Preparation of soil also involves ensuring that the temperature of the soil is at or above 10° C., in particular in those embodiments where the active ingredient is a compound that produces MITC as a degradate (such as metam sodium), or a functional equivalent thereof (such as an alternative Foc TR4 fumigant). Temperature may have an impact on the completeness as well as the speed with which a compound degrades to produce MITC.

Soil may optionally be analyzed for the presence of Foc TR4 prior to the application of MITC or a compound that produces MITC as a degradate (such as metam sodium), or a functional equivalent thereof (such as an alternative Foc TR4 fumigant). The analysis optionally involves obtaining samples at set intervals in a field of soil and at specific depths (e.g. 20 cm, 40 cm, 60 cm), then testing for the presence and/or quantifying the amount of viable Foc TR4 propagules in a set soil amount.

### Application to Soil

Application of MITC or compound(s) that produces MITC as a degradate (such as metam sodium), or a functional equivalent thereof (such as an alternative Foc TR4 fumigant), to soil occurs by machine. The machine used to inject the formulation into (or in some cases, onto) the soil includes shanks that can reach at least 60 cm in depth. The machine is used in combination with a tractor, generally with a minimum horsepower of 150 in order to readily drive the injection shoes through the soil during application.

To apply the MITC or compound that produces MITC as a degradate (such as metam sodium), or a functional equivalent thereof (such as an alternative Foc TR4 fumigant, to a field, the machine is set at the starting point of application and the shanks. The shanks on the machine are lowered and the tractor moves forward sinking the shanks into the ground to reach the appropriate depth. The machine then makes injections of the formulation into the soil and proceeds until the tractor reaches a limit of the field and then stops the injection. The tractor then turns around with the machine and repeats the process until the entire field is covered. The entire process can be repeated again to apply the formulation at a second depth.

More generally, it will be recognized that soil fumigants may be applied using several methods that may work for use in the current disclosure so long as the end result is application of the MITC or compound(s) that produces MITC as a degradate (such as metam sodium), or a functional equivalent thereof (such as an alternative Foc TR4 fumigant), to (1) at least 40 cm below the surface of the soil, (2) at two depths between 0 cm and 60 cm below the soil surface (where at least one depth is at least 40 cm), or (3) mixing or blending soil treated with MITC or compound(s) that produces MITC as a degradate (such as metam sodium), or a functional equivalent thereof (such as an alternative Foc TR4 fumigant) such that at least 60 cm below the soil surface contains sufficient active agent to reduce the Foc TR4 viable population in the soil column.

Dazomet is applied as a granular formulation that is soil incorporated. Other fumigants are liquids with high vapor pressure, so they are usually stored and applied as liquids (under pressure), which begin to vaporize shortly after injection in the soil.

Some soil fumigants can be applied by chemigation. Metam sodium, 1,3-Dichloropropene, and metam potassium can be metered into irrigation systems and applied via drip tape or sprinkler. It is noted, however, that soil so treated would then beneficially be tilled or otherwise mixed in in order to ensure distribution of the active ingredient at least to 60 cm below the surface of the soil.

The portion of the fields that is fumigated varies. In one embodiment or in combination with any of the mentioned embodiments, the entire field is treated. This is termed “flat fume”, “broadcast”, or “broadacre.” Fumigants are applied using granular spreaders (dazomet), or are shanked- or knifed-in to the soil as described herein, followed by soil incorporation or surface compaction of the soil for instance using a roller. Optionally, treated soil may be tarped or otherwise sealed for a period of time after application of the fumigant, for instance for at least 24 hours, at least 2 days, at least 3 days, at least 4 days, at least 5 days, or more than five days after treatment.

Fumigation may also occur when planting beds are formed. A bed press forms a raised bed and the fumigant is injected into the bed as it is formed. The entire bed, or only the portion of the bed, is fumigated. This is termed “strip” treatments. Alternatively, the entire field is fumigated and tarped. The tarps are then removed, raised beds are formed, and these beds are then tarped.

For all methods of application, the condition of the soil (e.g., soil texture, moisture, temperature) is critical to achieving the desired results from the fumigation.

Often after the fumigation is completed, the fumigated area is tarped or water sealed in order to reduce emissions from the field. There are a range of tarps used to reduce the emissions from soil applications of fumigants. Pre-planting soil applications may use low density polyethylene (LDPE) or high-density polyethylene (HDPE) tarps to reduce emissions.

Another method of reducing emissions of metam sodium, metam potassium, and dazomet is the use of water seals. This method involves applying additional water after fumigation. Depending on the amounts and frequency of applying additional irrigation water these seals are termed standard or intermittent.

Once the appropriate concentration of a MITC- or compound(s) that produces MITC as a degradate (such as metam sodium)-containing formulation (a ready-to-use (RTU) or “as-applied” composition) has been prepared, the formulation may be deposited on or into soil in which plants or crops are to be planted and grown.

In one embodiment or in combination with any of the mentioned embodiments, the formulation that contains MITC or a compound(s) that produces MITC as a degradate (such as metam sodium), or a functional equivalent thereof (such as an alternative Foc TR4 fumigant), is distributed or applied using broadcast spraying or spreading or directed application. Broadcast spreading typically is used when a product needs to be distributed over a larger area such as across a field which enables the product to spread across the field. Broadcast spreading may take various forms such as via handheld sprayer (with appropriate protective gear), tractor, or other means. In contrast, directed application is normally used when there is a desire to apply the product to a specific area of the field or crops. Directed applications may be applied via tractor or other depositing device. In the case of surface distribution of the formulation that includes MITC or compound(s) that produces MITC as a degradate (such as metam sodium), or a functional equivalent thereof (such as an alternative Foc TR4 fumigant), the formulation is subsequently mixed into the soil to a depth of at least 60 cm immediately or essentially immediately after application, and the soil surface is sealed as described herein in order to maintain the MITC in contact with the soil.

By way of example, the MITC or compound(s) that produces MITC as a degradate (such as metam sodium), or a functional equivalent thereof (such as an alternative Foc TR4 fumigant), containing formulation may be deposited in a tank or other container. The tank may then be sealed and optionally pressurized at which point the tank may be connected to any desired distribution device (e.g. sprayer, tractor, or specialized injector machine) and administered to the soil as desired. Beneficially, the product can be administered sub-soil via injection prior to the field being planted.

By way of non-limiting example, the following provides a system for carrying out an embodiment for application of metam sodium to soil in order to reduce or control transmission of Foc TR4 in Musa plants subsequently planted in the treated soil:
1) Soil preparation:
   use a rototiller to at least break the soil structure from 0 cm to 80 cm deep to allow the injection to have a smooth and even application by the machine.
   soil should be leveled, uniform, so the machine and the tractor can advance at a similar pace in all soil in which the Metam Sodium injection will take place.
   soil should be humid, at least between 50-60% field capacity to ensure the best efficacy of the product over the fungi
2) Machine transportation: machine should be in place before the application
3) Metam transportation: product should be in place before the application
4) Personal Protection Equipment (PPE): a. appropriate PPE for the people that will work making the injection of the product, including: rubber boots, rubber gloves, mask with filters, coveralls
5) Soil analysis is recommended before and after metam sodium injection, to determine presence of Foc TR4
6) Plants to be planted in field after treatment are recommended to be certified Foc TR4-free, such as in vitro produced plants, to avoid any plants already contaminated
7) Need to have a tractor with at least 150 HP, the tractor can be of any brand
8) Connect the soil-injection machine (which is able to deliver the anti-fungal composition below the soil to a depth of 0 cm to 60 cm or more below the soil surface) to the tractor
9) Configure the computer that programs the injection machine for the desired product application specifications (rate, depth, etc.)
10) Workers put on PPE
11) The product is loaded into the machine
12) Once the product is loaded, the tractor and machine are moved to the field to be treated with metam sodium
13) Once in the field, with the product loaded:
   a. The shanks are lowered
   b. The tractor is moved forward so the shanks get into the ground to the programmed depth
   c. Injection of metam sodium into the soil is initiated
   d. When the tractor reaches a limit of the field and has to turn around, the metam sodium injection is turned off
   e. The tractor and machine are turned around
   f. The process is repeated until application is finished
   g. Optionally, application may be repeated immediately for the entire field, for instance at a second depth
   h. Optionally, the soil is tilled after the product is injected or applied, in order to distribute the product more thoroughly through and/or more deeply into the soil column
   i. The soil is compacted or otherwise sealed (e.g., covered with a tarp or other enclosure) after treatment with the metam sodium product
14) When the metam sodium injection is completed, any leftover metam sodium solution is unloaded from the machine following standard and safe procedures
15) After metam sodium is removed, to wash the machine using standard procedures
16) Workers can remove PPE after cleaning the machine

### (IX) Methods for Cyclic Treatment and Planting to Extend Productivity

Also provided herein are methods of growing plants of the genus Musa in a field known or believed to be infected with Fusarium oxysporum f. sp. Cubense Tropical Race 4 (Foc TR4), the method comprising at least two repetitions of a treatment and planting cycle that includes: introducing to at least 40 cm below the surface of soil in the field an Foc TR4 inhibiting effective amount of a composition comprising methyl isothiocyanate (MITC) or a compound that produces MITC as a degradate (or a functional equivalent thereof, such as an alternative Foc TR4 fumigant), allowing the MITC to reduce viable Foc TR4 propagule count in the soil, to produce treated soil; planting plants of the genus Musa into the treated soil; growing the plants of the genus Musa for a plurality of years; harvesting fruit from at least one of the plants of the genus Musa each of the plurality of years; and removing the plants of the genus Musa from the field. For instance, in examples of these methods the plurality of years in at least one repetition of the treatment and planting cycle includes 2 years, 3 years, 4 years, 5 years, 6 years, 7 years, 8 years, 9 years, 10 years, or 11-15 years.

Optionally, in examples of these methods, introducing the composition to at least 40 cm below the surface of soil in the field comprises applying the composition to the soil: at two depths between 0 cm and 60 cm below the soil surface, wherein a first depth is at least 40 cm below the soil surface and a second depth is 0 to less than 40 cm below the soil surface; or to produce treated soil; and mixing/blending the treated soil to a depth of at least 60 cm; or at two depths between 0 centimeter and 60 cm below the surface, wherein a first depth is at least 40 cm below the surface and a second depth is 0 to less than 40 cm below the surface; and blending the soil such the composition and/or degradate(s) derived therefrom is distributed throughout the soil to a depth of more than 40 cm.

The Additional Disclosure and Examples below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### (X) Additional Disclosure

One provided embodiment is a method of reducing Fusarium oxysporum f. sp. Cubense Tropical Race 4 (Foc TR4) (a.k.a. Fusarium odoratissimum) propagules in soil of a Musa field, including applying a including methyl isothiocyanate (MITC) or a compound that produces MITC as a degradate (or a functional equivalent or alternative thereof), wherein application of the composition reduces Foc TR4 propagule count in the soil by at least 15% compared to the Foc TR4 propagule count in the soil before treatment.

In one method embodiment, or in combination with any of the mentioned embodiments, the Foc TR4 propagule count is reduced by: more than 20%, at least 25%, at least 30%, at least 40%, at least 50%, at least 60%, at least 70%, or more than 75%, compared to the Foc TR4 propagule count in the soil before treatment. By way of example, the Foc TR4 propagules include one or more of spores, hyphae, or hyphal fragments capable of producing infection in a Musa plant.

In one method embodiment, or in combination with any of the mentioned embodiments, at least one Musa tree is planted in the Musa field after the composition is applied.

In one method embodiment, or in combination with any of the mentioned embodiments, the compositions includes: metam sodium (such as sodium N-methyldithiocarbamate; or methyldithiocarbamic acid sodium salt), metam potassium (such as potassium N-methyldithiocarbamate; or methyldithiocarbamic acid potassium salt), metam ammonium, or dazomet.

In any method embodiment, or in combination with any of the mentioned embodiments, the composition may further includes a surfactant, a spreading agent, a wetting agent, an emulsifier, a thickening agent, a sticking agents, a penetrating agent, a humectant, a dispersing agent, an antifoaming agent, a compatibility agent, a micronutrient, a preservative, a solvent, a colorant, a fragrance, or a combination of two or more thereof.

In one method embodiment, or in combination with any of the mentioned embodiments, the composition includes N-octyl pyrrolidone (NOP), Xiameter, Soprophor, Ethilformate, or two or more thereof.

In one method embodiment, or in combination with any of the mentioned embodiments, the composition forms methyl isothiocyanate (MITC) when applied to the soil.

In one method embodiment, or in combination with any of the mentioned embodiments, the composition includes: 300-700 grams of methyldithiocarbamate equivalents per liter of solution; 400-600 grams of methyldithiocarbamate equivalents per liter of solution; 425-575 grams of methyldithiocarbamate equivalents per liter of solution; 450-550 grams of methyldithiocarbamate equivalents per liter of solution; 475-525 grams of methyldithiocarbamate equivalents per liter of solution; 500-525 grams of methyldithiocarbamate equivalents per liter of solution; or 505-515 grams of methyldithiocarbamate equivalents per liter of solution.

In one method embodiment, or in combination with any of the mentioned embodiments, the soil has a water holding capacity, and at the time of treatment, contains water at a level of: 40% - 80% of the water holding capacity of the soil; 45% - 75% of the water holding capacity of the soil; 50% -70% of the water holding capacity of the soil; or 55% - 65% of the water holding capacity of the soil.

In one method embodiment, or in combination with any of the mentioned embodiments, the composition is applied to the soil at a rate of: 500 -5,000 liters per hectare; 550-4,500 liters per hectare; 600-4,000 liters per hectare; 650-4,000 liters per hectare; 700-5,000 liters per hectare; or 750-3,000 liters per hectare.

In one method embodiment, or in combination with any of the mentioned embodiments, the soil is in a field.

Also provided are method embodiments, including in combination with any of the mentioned embodiments, that further include planting at least one Musa tree in the treated soil after applying the composition. By way of example, the at least one Musa tree is planted in the treated soil: at least 3 days after the treatment; at least 5 days after the treatment; at least 7 days after the treatment; at least 10 days after the treatment; at least 12 days after the treatment; at least 14 days after the treatment; or more than 14 days after the treatment. In an example of this method embodiment, or in combination with any of the mentioned embodiments, the Musa tree is a Musa acuminata banana plant or a plantain plant. For instance, the Musa acuminata banana plant is optionally a Cavendish triploid (AAA) cultivar banana plant. Similarly, the plantain plant is optionally a Plantain triploid (AAB) Musa acuminata and Musa balbisiana hybrid plant.

In one method embodiment, or in combination with any of the mentioned embodiments, applying the composition to the soil includes one or more of: injection application using shank/chisel blade drawn by a tractor or other motorized machine; injection application using a goose foot blade drawn by a tractor or other motorized machine; mixing at least some of the soil to distribute the composition or a degradate thereof; tilling the soil; or disking the soil.

### Specific Embodiments

Embodiment 1. A method of reducing Fusarium oxysporum f. sp. Cubense Tropical Race 4 (Foc TR4) (a.k.a. Fusarium odoratissimum) propagules in soil of a Musa field, comprising applying a comprising methyl isothiocyanate (MITC) or a compound that produces MITC as a degradate (or a functional equivalent or alternative thereof), wherein application of the composition reduces Foc TR4 propagule count in the soil by at least 15% compared to the Foc TR4 propagule count in the soil before treatment.

Embodiment 2. The method of Embodiment 1, wherein the Foc TR4 propagule count is reduced by: more than 20%, at least 25%, at least 30%, at least 40%, at least 50%, at least 60%, at least 70%, or more than 75%, compared to the Foc TR4 propagule count in the soil before treatment.

Embodiment 3. The method of any one of Embodiment 1 or Embodiment 2, wherein the Foc TR4 propagules comprise one or more of spores, hyphae, or hyphal fragments capable of producing infection in a Musa plant.

Embodiment 4. The method of any one of Embodiments 1-3, wherein at least one Musa tree is planted in the Musa field after the composition is applied. Embodiment 5. The method of any one of Embodiments 1-4, wherein the compositions comprises: metam sodium, metam potassium, metam ammonium, or dazomet.

Embodiment 6. The method of Embodiment 4, wherein the metam sodium comprises: sodium N-methyldithiocarbamate; or methyldithiocarbamic acid sodium salt.

Embodiment 7. The method of Embodiment 4, wherein the metam potassium comprises: potassium N-methyldithiocarbamate; or methyldithiocarbamic acid potassium salt.

Embodiment 8. The method of any one of Embodiments 1-7, wherein the composition further comprises a surfactant, a spreading agent, a wetting agent, an emulsifier, a thickening agent, a sticking agents, a penetrating agent, a humectant, a dispersing agent, an antifoaming agent, a compatibility agent, a micronutrient, a preservative, a solvent, a colorant, a fragrance, or a combination of two or more thereof.

Embodiment 9. The method of Embodiment 8, wherein the composition comprises N-octyl pyrrolidone (NOP), Xiameter, Soprophor, Ethilformate, or two or more thereof.

Embodiment 10. The method of any one of Embodiments 1-9, wherein the composition forms methyl isothiocyanate (MITC) when applied to the soil.

Embodiment 11. The method of any one of Embodiments 1-10, wherein the composition comprises: 300-700 grams of methyldithiocarbamate equivalents per liter of solution; 400-600 grams of methyldithiocarbamate equivalents per liter of solution; 425-575 grams of methyldithiocarbamate equivalents per liter of solution; 450-550 grams of methyldithiocarbamate equivalents per liter of solution; 475-525 grams of methyldithiocarbamate equivalents per liter of solution; 500-525 grams of methyldithiocarbamate equivalents per liter of solution; or 505-515 grams of methyldithiocarbamate equivalents per liter of solution.

Embodiment 12. The method of any one of Embodiments 1-11, wherein the soil has a water holding capacity, and at the time of treatment, contains water at a level of: 40%-80% of the water holding capacity of the soil; 45%-75% of the water holding capacity of the soil; 50%-70% of the water holding capacity of the soil; or 55%-65% of the water holding capacity of the soil.

Embodiment 13. The method of any one of Embodiments 1-12, wherein the composition is applied to the soil at a rate of: 500-5,000 liters per hectare; 550 -4,500 liters per hectare; 600-4,000 liters per hectare; 650-4,000 liters per hectare; 700-5,000 liters per hectare; or 750-3,000 liters per hectare.

Embodiment 14. The method of any one of Embodiments 1-13, where the soil is in a field.

Embodiment 15. The method of any one of Embodiments 1-15, further comprising planting at least one Musa tree in the treated soil after applying the composition.

Embodiment 16. The method of Embodiment 15, wherein the at least one Musa tree is planted in the treated soil: at least 3 days after the treatment; at least 5 days after the treatment; at least 7 days after the treatment; at least 10 days after the treatment; at least 12 days after the treatment; at least 14 days after the treatment; or more than 14 days after the treatment.

Embodiment 17. The method of any one of Embodiment 15 or Embodiment 16, wherein the Musa tree is a Musa acuminata banana plant or a plantain plant.

Embodiment 18. The method of Embodiment 17, wherein the Musa acuminata banana plant is a Cavendish triploid (AAA) cultivar banana plant.

Embodiment 19. The method of Embodiment 17, wherein the plantain plant is a Plantain triploid (AAB) Musa acuminata and Musa balbisiana hybrid plant. Embodiment 20. The method of any one of Embodiments 1-19, wherein applying the composition to the soil comprises one or more of:
injection application using shank/chisel blade drawn by a tractor or other motorized machine;
injection application using a goose foot blade drawn by a tractor or other motorized machine;
mixing at least some of the soil to distribute the composition or a degradate thereof;
tilling the soil; or
disking the soil.

### (XI) Examples

### Example 1. Efficacy of Metam Sodium Towards Fusarium Oxysporum f. sp. Cubense

Fusarium oxysporum f. sp. Cubense (Foc) is the causal agent of Panama disease and poses a great risk to the global banana production. During the middle of the 20th century, the banana Gros Michel was wiped out due to Foc Race 1. Due to decimation of the Gros Michel banana by Foc Race 1, the banana industry transformed to Cavendish banana. In the recent years Foc Tropical race 4 (TR4) began infecting Cavendish banana, first in Southeast Asia, then spreading out globally. Currently, Foc TR4 has been detected as far as Pakistan, Lebanon and Mozambique.

The spread of Foc TR4 is mainly due to human behavior, such as the movement of contaminated banana suckers, people, and equipment. Once in the soil, the chlamydospores of Foc TR4 can survive for more than 30 years. Metam sodium has been found very effective against various fungal diseases (McGovern et al., Plant Disease, 82(8):919-923, 1998). Described in this example is an investigation on the efficacy of metam sodium on chlamydospores of Foc TR4 in vitro.

### Methods

Foc TR4 chlamydospores were extracted from infested soil and incubated with a dilution series of metam sodium for 5 min and 60 min at room temperature. Thereafter, the samples were diluted 10X to get reduction of the treatment and sufficient dilution of chlamydospores to avoid lack of resolution when grown on plate. Aliquots of 100 µl were plated on PDA plates in duplicate and incubated for 3 days at 25° C. Plates were photographed and scored.

### Results

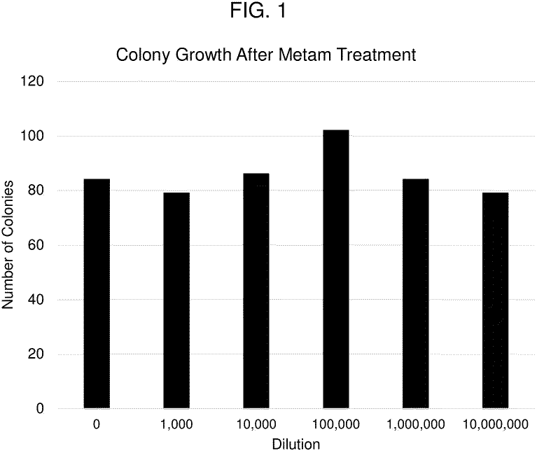

First test. A first test was performed with metam sodium at dilutions starting from 1000 up to 10 X 10⁶-fold dilution (60 min). No significant reduction in viability was observed at these concentrations (FIG. 1).

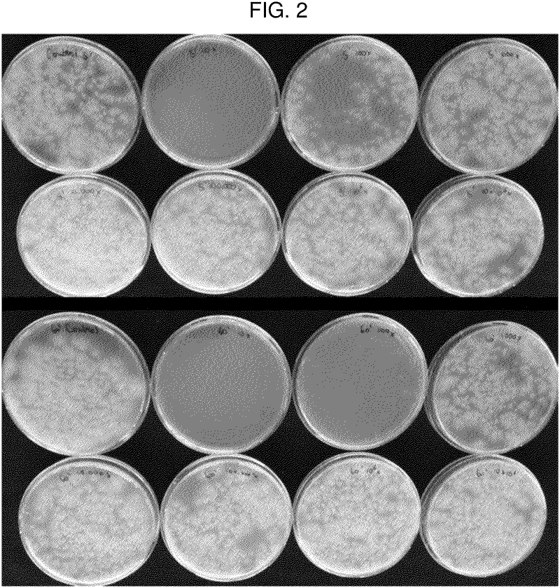

Second test. Due to the lack of efficacy in the first test, the experiment was repeated starting with 10X dilutions. Dilutions of 1000X and more did not affect the number of chlamydospores that survived, confirming the initial experiment. However, 10X and 100X dilutions were (partially) effective (FIG. 2).

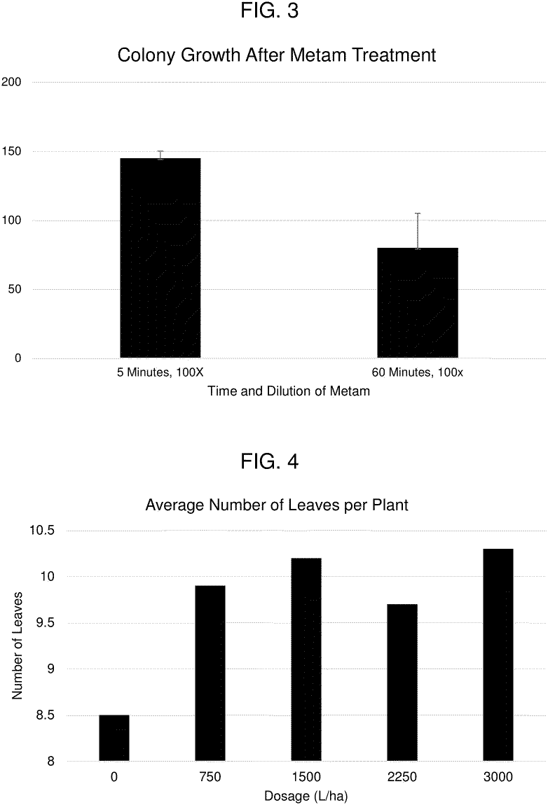

From the plates shown in FIG. 2, it is clear that metam sodium is effective at a dilution of 10X, with incubation time of 5 minutes. At a dilution of 100X the compound is less effective at both 5 and 60 minutes. The colonies were counted for the 100X dilution and are summarized in FIG. 3. Prolonged incubation was more effective in reducing the number of surviving chlamydospores, measured as growing colonies.

### Discussion

The emergence of Foc TR4 in the Cavendish banana dominated production worldwide highlights the urgency of products that can decrease or reduce the incidence of Panama disease.

Here metam sodium, a compound that can be applied onto or injected into soil, was tested as a treatment for reducing the number of viable Foc TR4 chlamydospores. These data demonstrated that under in vitro conditions, metam sodium is effective against Foc TR4 chlamydospores. The effectiveness of the compound is dependent on high concentrations.

These data provide support for proposal that metam sodium can be effective in an integrated approach to reduce Foc TR4 infestations in the soil.

### Example 2. Treatment of a Musa Field With Metam Sodium at Multiple Depths of Application

Banana is the most exported fruit in the world, and the 5th most produced in the least developed countries, being a valuable market commodity but also an important staple food or source of income in developing countries for approximately 400 M people. This crop is under threat by serious soil disease, as it is being affected by Fusarium oxysporum f. sp. Cubense Tropical Race 4 (Foc TR4). Infection of banana plants by Foc TR4 jeopardizes their continuous production and productivity.

Currently, there is no chemical, organic or non-organic, being used effectively against Foc TR4. It would be beneficial to develop an application method to introduce metam sodium into the soil of fields into which bananas or plantains are to be planted, in order to reduce Foc TR4 infestation and/or damage to the plants. This Example examines the effect of injection of metam sodium at selected depths below the soil surface, with an efficient application to protect the root zone with the necessary amount of metam sodium to mitigate the problems and promote or continue stable crop production.

The analyses described in this example were carried out in the Philippines in a field in which Musa trees (specifically bananas) were to be planted, in the spring (beginning in March). Final determinations were carried out in September of the same year.

### Methods

Metam Sodium Application. Metam sodium 510 SL (equivalent to 42% w/w) was applied to soil at the following doses: 0 liters per hectare (L/ha), 750 L/ha, 1500 L/ha, 2250 L/ha, 3000 L/ha.

Prior to injection, soil was prepared using a rototiller to break the soil structure from 0 cm to 80 cm deep, allowing for the smooth and even injection application by an injection machine. The soil was then leveled and made uniform, and the metam sodium was applied at two depths: 30 cm and 60 cm, using injection methods. The temperature was at a minimum of 10° C. and soil humidity was between 50 and 60% holding capacity, allowing the applied product to transform from metam sodium (liquid) to MITC (gas).

The application was made using an injection machine wherein the machine lowered shanks and began moving forward such that the shanks lowered to a depth of 60 cm and injectors applied the metam sodium into the soil. When the injection at 60 cm was complete, the process was repeated for the entire field at 30 cm. The treated soil in the field was then sealed using a packer roller (which was part of the injection machinery, located at the back end of the machine), after each application.

Soil Analysis. Soil samples were obtained at 20, 40, and 60 cm before application and every 24 hours beginning 48 hours after application, for seven days.

Plant Pathology Analysis. Soil samples used for Panama Disease and nematode analyses were aseptically isolated in culture medium and incubated for seven days at room temperature. Organisms were identified as follows: 20 grams of composite soil sample was diluted with 40 mL distilled water (dH₂O); 1 drop of Tween 20 detergent was added, and the sample mixed. A 1 mL aliquot was taken from the solution and diluted with 9 mL dH₂O; three further serial dilutions were made. From each dilution, 100 µL were spread on solid Komada growth medium (Sun et al., Phytopathology 68: 1672-1673, 1978). Growth could be seen 7 days after inoculation.

Plant Selection and Transplantation. Cavendish banana plants were used for this investigation. In order to avoid plants already contaminated by other soil, all plants were produced in vitro using art-recognized methods. Plants were transplanted into the field 14 days after the final soil reading was taken (21 days after treatment).

Data Gathering. Data were gathered at monthly intervals beginning three months after banana plants were transplanted. A total of three data collection sessions were conducted. Data including the number of leaves, plant height, and girth size were collected.

### Results

Average number of leaves. Metam sodium application increased the average number of leaves. There was a roughly 1.5-fold leaf increase with the use of metam sodium, regardless of dose applied (FIG. 4).

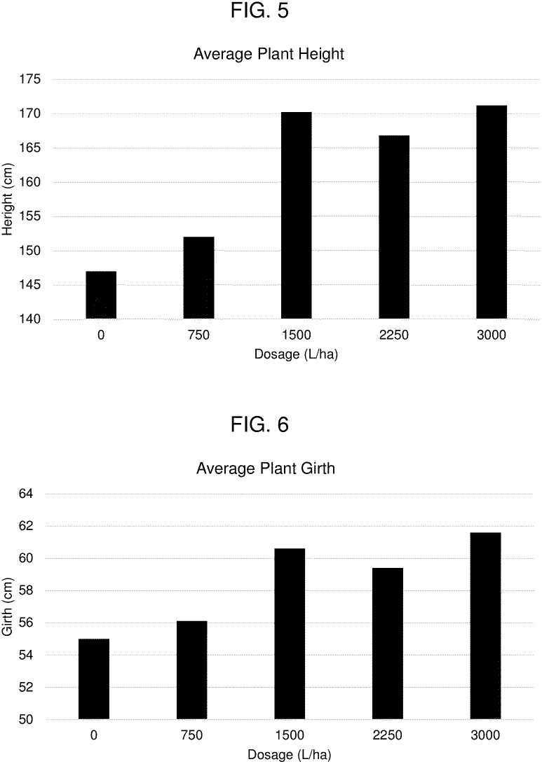

Average height of banana plant. There was an effect of metam sodium on the average height of banana plants. The lowest dose (750 L/ha) led to a modest increase (~5 cm) while the moderate to high doses (1500-3000 L/ha) lead to larger increases (~20-23 cm) in plant height (FIG. 5).

Average girth size of banana plant. There was an effect of Metam sodium on the average girth size of banana plants. The lowest dose (750 L/ha) had minimal effects on girth size (~1 cm) while the moderate to high doses (1500-3000 L/ha) lead to larger increases (~4-6 cm) in girth size (FIG. 6).

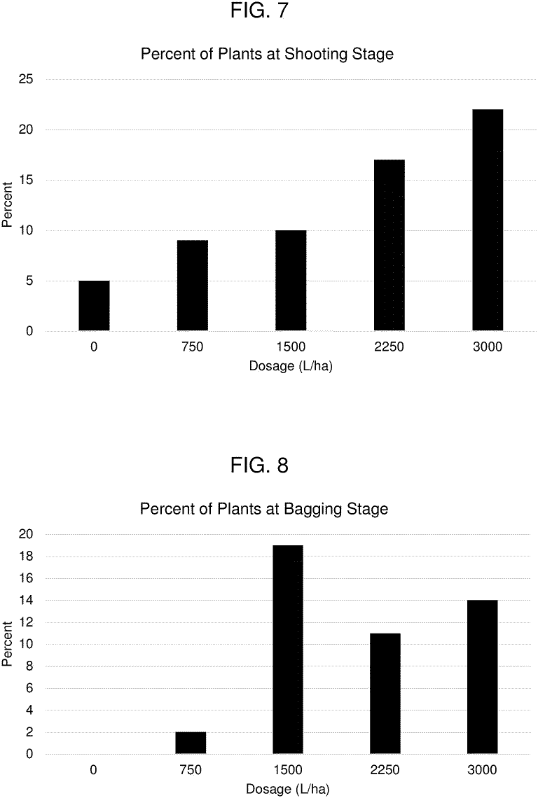

Percent of plants at shooting stage. There was a dose response effect observed with regard to metam sodium treatment and plants reaching shooting stage. At 0 L/ha, only 5% of plants were at shooting stage by six months after treatment, while 9%, 10%, 17%, and 22% of plants reached shooting stage at 750, 1500, 2250, and 3000 L/ha (FIG. 7).

Percent of plants at bagging stage. Low doses of metam sodium (750 L/ha) did not have a meaningful effect on plants reaching bagging stage by six months after treatment. However, at doses of 1500 to 3000 L/ha, 11-19% of plants reached bagging stage (FIG. 8).

Percent of plants at either shooting or bagging stage. There was a dose response effect observed with regard to metam sodium treatment and plants reaching either shooting or bagging stage by six months after treatment.

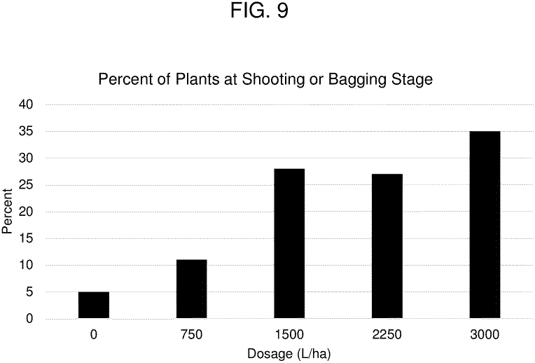

At 0 L/ha, only 5% of plants were at shooting stage, while 11%, 28%, 27%, and 35% of plants reached shooting or bagging stage at 750, 1500, 2250, and 3000 L/ha (FIG. 9).

Soil Contamination. No Foc TR4 was detected in any of the treated groups at any day post application (Table 1). Foc TR4 was detected in positive control samples in a parallel analysis. Similarly, no parasitic nematodes were noted in any tested soil samples. In the following Table, T1-T5 indicates the treatment as follows: T1 - no metam sodium (MNa); T2 - 750 L/ha MNa; T3 -1500 L/ha MNa; T4 - 2250 L/ha MNa; T5 - 3000 L/ha MNa.

TABLE 1

Panama disease analysis.

| Sample Day | Source | | Panama Disease |
|---|---|---|---|
| | | | F. oxysporum f. sp. cubense |
| Day 1 | 20 cm | T1 | - |
| | | T2 | - |
| | | T3 | - |
| | | T4 | - |
| | | T5 | - |
| | 40 cm | T1 | - |
| | | T2 | - |
| | | T3 | - |
| | | T4 | - |
| | | T5 | - |
| | 60 cm | T1 | - |
| | | T2 | - |
| | | T3 | - |
| | | T4 | - |
| | | T5 | - |
| Day 2 | 20 cm | T1 | - |
| | | T2 | - |
| | | T3 | - |
| | | T4 | - |
| | | T5 | - |
| | 40 cm | T1 | - |
| | | T2 | - |
| | | T3 | - |
| | | T4 | - |
| | | T5 | - |
| | 60 cm | T1 | - |
| | | T2 | - |
| | | T3 | - |
| | | T4 | - |
| | | T5 | - |
| Day 3 | 20 cm | NA | NA |
| | | T2 | - |
| | | T3 | - |
| | | T4 | - |
| | | T5 | - |
| | 40 cm | NA | NA |
| | | T2 | - |
| | | T3 | - |
| | | T4 | - |
| | | T5 | - |
| | 60 cm | NA | NA |
| | | T2 | - |
| | | T3 | - |
| | | T4 | - |
| | | T5 | - |
| Day 4 | 20 cm | NA | NA |
| | | T2 | - |
| | | T3 | - |
| | | T4 | - |
| | | T5 | - |
| | 40 cm | NA | NA |
| | | T2 | - |
| | | T3 | - |
| | | T4 | - |
| | | T5 | - |
| | 60 cm | NA | NA |
| | | T2 | - |
| | | T3 | - |
| | | T4 | - |
| | | T5 | - |
| Day 5 | 20 cm | NA | NA |
| | | T2 | - |
| | | T3 | - |
| | | T4 | - |
| | | T5 | - |
| | 40 cm | NA | NA |
| | | T2 | - |
| | | T3 | - |
| | | T4 | - |
| | | T5 | - |
| | 60 cm | NA | NA |
| | | T2 | - |
| | | T3 | - |
| | | T4 | - |
| | | T5 | - |
| Day 6 | 20 cm | NA | NA |
| | | T2 | - |
| | | T3 | - |
| | | T4 | - |
| | | T5 | - |
| | 40 cm | NA | NA |
| | | T2 | - |
| | | T3 | - |
| | | T4 | - |
| | | T5 | - |
| | 60 cm | NA | NA |
| | | T2 | - |
| | | T3 | - |
| | | T4 | - |
| | | T5 | - |
| Day 7 | 20 cm | NA | NA |
| | | T2 | - |
| | | T3 | - |
| | | T4 | - |
| | | T5 | - |
| | 40 cm | NA | NA |
| | | T2 | - |
| | | T3 | - |
| | | T4 | - |
| | | T5 | - |
| | 60 cm | NA | NA |
| | | T2 | - |
| | | T3 | - |
| | | T4 | - |
| | | T5 | - |

Similarly, no parasitic nematodes were noted in any tested soil samples; see Table 2.

TABLE 2

Nematode Population Analysis

| | Nematode Population / 100 g of Soil | | | | | | Total |
|---|---|---|---|---|---|---|---|
| Sample # | A* | B | c | D | E | F | |
| T1 R1 | 0 | 0 | 0 | 0 | 0 | 250 | 250 |
| T1 R2 | 0 | 0 | 0 | 0 | 0 | 42 | 42 |
| T1 R3 | 0 | 0 | 0 | 0 | 0 | 83 | 83 |
| T1 R4 | 0 | 0 | 0 | 0 | 0 | 209 | 209 |
| Total | 0 | 0 | 0 | 0 | 0 | 583 | 583 |
| Mean | 0 | 0 | 0 | 0 | 0 | 146 | 146 |

*A=Radopholus; B=Pratylenchus; C=Meloidogyne; D=Helicotylenchus; E= Hoplolaimus; F=Others (non-parasitic nematode)

### (XII) Closing Paragraphs

As will be understood by one of ordinary skill in the art, each embodiment disclosed herein can comprise, consist essentially of, or consist of its particular stated element, step, ingredient or component. Thus, the terms “include” or “including” should be interpreted to recite: “comprise, consist of, or consist essentially of.” The transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

A material effect, in this context, is a measurable alteration in the success of a compound, system, or method to reduce or control a fungal pathogen, or to support growth of a Musa plant and/or production of fruit therefrom. For instance, a material effect may be anything that would significantly alter how effective a formulation or method is at controlling or influencing the infection rate of Foc TR4 in plants of the genus Musa.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents, printed publications, journal articles and other written text throughout this specification (referenced materials herein). Each of the referenced materials is individually incorporated herein by reference in its entirety for the referenced teaching, to the extent it does not contradict any specific teachings provided herein.

It is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

Definitions and explanations used in the present disclosure are meant and intended to be controlling in any future construction unless clearly and unambiguously modified in the example(s) or when application of the meaning renders any construction meaningless or essentially meaningless. In cases where the construction of the term would render it meaningless or essentially meaningless, the definition should be taken from Webster’s Dictionary, 3rd Edition or a dictionary known to those of ordinary skill in the art, such as the Oxford Dictionary of Biochemistry and Molecular Biology (Ed. Anthony Smith, Oxford University Press, Oxford, 2004).

1. A method of reducing Fusarium oxysporum f. sp. Cubense Tropical Race 4 (Foc TR4) (a.k.a. Fusarium odoratissimum) propagules in soil of a Musa field, comprising applying a comprising methyl isothiocyanate (MITC) or a compound that produces MITC as a degradate (or a functional equivalent or alternative thereof), wherein application of the composition reduces Foc TR4 propagule count in the soil by at least 15% compared to the Foc TR4 propagule count in the soil before treatment.

2. The method of claim 1, wherein the Foc TR4 propagule count is reduced by: more than 20%, compared to the Foc TR4 propagule count in the soil before treatment.

3. The method of claim 1 , wherein the Foc TR4 propagules comprise one or more of spores, hyphae, or hyphal fragments capable of producing infection in a Musa plant.

4. The method of claim 1 , wherein at least one Musa tree is planted in the Musa field after the composition is applied.

5. The method of claim 1 , wherein the compositions comprises:
metam sodium, metam potassium, metam ammonium, or dazomet.

6. The method of claim 4, wherein the metam sodium comprises:
sodium N-methyldithiocarbamate; or
methyldithiocarbamic acid sodium salt.

7. The method of claim 4, wherein the metam potassium comprises:
potassium N-methyldithiocarbamate; or
methyldithiocarbamic acid potassium salt.

8. The method of claim 1 , wherein the composition further comprises a surfactant, a spreading agent, a wetting agent, an emulsifier, a thickening agent, a sticking agents, a penetrating agent, a humectant, a dispersing agent, an antifoaming agent, a compatibility agent, a micronutrient, a preservative, a solvent, a colorant, a fragrance, or a combination of two or more thereof.

9. The method of claim 8, wherein the composition comprises N-octyl pyrrolidone (NOP), Xiameter, Soprophor, Ethilformate, or two or more thereof.

10. The method of claim 1 , wherein the composition forms methyl isothiocyanate (MITC) when applied to the soil.

11. The method of claim 1 , wherein the composition comprises: 300-700 grams of methyldithiocarbamate equivalents per liter of solution.

12. The method of claim 1 , wherein the soil has a water holding capacity, and at the time of treatment, contains water at a level of: 40%-80% of the water holding capacity of the soil.

13. The method of claim 1 , wherein the composition is applied to the soil at a rate of: 500-5,000 liters per hectare.

14. The method of claim 1 ,where the soil is in a field.

15. The method of claim 1 , further comprising planting at least one Musa tree in the treated soil after applying the composition.

16. The method of claim 15, wherein the at least one Musa tree is planted in the treated soil: at least 3 days after the treatment.

17. The method of claim 15 , wherein the Musa tree is a Musa acuminata banana plant or a plantain plant.

18. The method of claim 17, wherein the Musa acuminata banana plant is a Cavendish triploid (AAA) cultivar banana plant.

19. The method of claim 17, wherein the plantain plant is a Plantain triploid (AAB) Musa acuminata and Musa balbisiana hybrid plant.

20. The method of claim 1 , wherein applying the composition to the soil comprises one or more of:
injection application using shank/chisel blade drawn by a tractor or other motorized machine;
injection application using a goose foot blade drawn by a tractor or other motorized machine;
mixing at least some of the soil to distribute the composition or a degradate thereof;
tilling the soil; or
disking the soil.
